(19) United States
(12) Patent Application Publication
(10) Pub. No.: US 2008/0301925 A1
(43) Pub. Date: Dec. 11, 2008

(54) HAND TOOL FOR REMOVING AND INSTALLING RUBBER COMPONENTS ON MILKING EQUIPMENT

(76) Inventors: Rodney L. Showalter, Dalton, OH (US); Brian D. Showalter, Dalton, OH (US)

Correspondence Address: SAND & SEBOLT, AEGIS TOWER, SUITE 1100, 4940 MUNSON STREET, NW, CANTON, OH, 44718-3615, US

(21) Appl. No.: 12/128,666

(22) Filed: May 29, 2008

Related U.S. Application Data
(60) Provisional application No. 60/933,560, filed on Jun. 7, 2007.

(51) Int. Cl. B23P 19/02

(52) U.S. Cl. 29/450; 29/235

(57) ABSTRACT

A pliers-like hand tool is configured to install rubber or elastomeric components on rigid components and to remove them from rigid components, such as found in milking equipment. Some embodiments of the hand tool include attachment mounts for mounting various attachments used for the installation and/or removal of specific elastomeric components. The hand tool is configured for removal of elastomeric hoses from rigid pipes. The hand tool is also useful for installing an elastomeric inflation of a teat cup assembly within its shell and for removing it therefrom.

### CROSS REFERENCE TO RELATED APPLICATIONS

This application claims priority from U.S. Provisional Application Ser. No. 60/933,560 filed Jun. 7, 2007; the disclosure of which is incorporated herein by reference.

### TECHNICAL FIELD

The invention relates generally to a tool for removing and installing rubber components having a tubular structure. More particularly, the invention relates to a hand tool used for this purpose. Specifically, the invention relates to a hand tool used for removing rubber hoses from milking equipment and removing and installing the inflation of a teat cup assembly.

### BACKGROUND INFORMATION

In the dairy industry, a great deal of automated milking equipment is used for milking cows. This milking equipment utilizes various tubes or hoses which are formed of rubber or an elastomeric material. In order to ensure that the milking equipment is sanitary, it must be washed in fairly hot water which causes the various rubber tubes to form a strong adhesion to the various ports to which they are connected, said ports typically being formed of metal. Thus, it is difficult to remove the tubes from these ports or other pipes. In addition, the inflation which is used in a teat cup assembly for milking a cow is difficult both to remove and install from within the metal shell in which it is disposed during use. The present invention addresses these problems.

### BRIEF SUMMARY OF THE INVENTION

The present application provides a hand tool comprising: first and second handles pivotally connected to one another about a first axis; a first arm connected to the first handle and extending outwardly from adjacent the first axis; a second arm connected to the second handle and extending outwardly from adjacent the first axis; wherein in response to pivotal movement of the handles about the first axis toward one another, the first and second arms pivot relative to one another whereby the arms are configured for one of removing an elastomeric component from a rigid component and installing an elastomeric component on a rigid component.

The present application also provides a method comprising the step of: positioning a hand tool comprising first and second handles pivotally connected to one another so that a first arm connected to the first handle is adjacent a rigid component and a second arm connected to the second handle is adjacent an elastomeric component; and squeezing the first and second handles so that the handles pivot toward one another and the first and second arms pivot relative to one another to one of remove the elastomeric component from the rigid component and install the elastomeric component on the rigid component.

### BRIEF DESCRIPTION OF THE SEVERAL VIEWS OF THE DRAWINGS

FIG. 1 is a side elevational view of a cow and the milking equipment with which the tool of the present invention is used.

FIG. 2 is a top plan view of the first embodiment of the tool of the present invention.

FIG. 3 is a side elevational view of the first embodiment.

FIG. 4 is an end elevational view of the first embodiment from the attachment mounting end.

FIG. 5 is perspective view of the first attachment which is used with the first embodiment.

FIG. 6 is a perspective view of the second attachment which is used with the first embodiment.

FIG. 7 is a perspective view of the third attachment used with the first embodiment generally showing the front side thereof.

FIG. 8 is a perspective view of the third attachment generally showing its rear side.

FIG. 9 is a side elevational view of the first embodiment of the tool with two of the first attachments mounted thereon in preparation for removing one of the rubber hoses from the milking equipment.

FIG. 10 is similar to FIG. 9 and shows the tool removing the rubber hose.

FIG. 11 is a side elevational view of the first embodiment of the tool shown in the inflation-installing configuration.

FIG. 12 is a sectional view taken on line 12-12 of FIG. 11 showing the inflation prior to installation in the outer shell.

FIG. 13 is similar to FIG. 11 and shows the tool being operated to install the inflation in the shell.

FIG. 14 is a sectional view taken on line 14-14 of FIG. 13 showing the inflation having been installed.

FIG. 15 is a side elevational view of the first embodiment of the tool in the inflation-removing configuration positioned prior to removing the inflation from the outer shell.

FIG. 16 is a sectional view taken on line 16-16 of FIG. 15 showing the inflation prior to removal.

FIG. 17 is a fragmentary elevational view of the third attachment shown from the opposite side of that shown in FIG. 16 and shows the movement of the fingers.

FIG. 18 is similar to FIG. 15 and shows the first embodiment of the tool removing the inflation from the outer shell.

FIG. 19 is a sectional view taken on line 19-19 of FIG. 18 showing the inflation removal process.

FIG. 20 is a side elevational view of the second embodiment of the tool of the present invention.

FIG. 21 is a sectional view taken on line 21-21.

FIG. 22 is a side elevational view of the third embodiment of the tool of the present invention positioned in preparation for removal of the inflation from its outer shell.

FIG. 23 is a top plan view of a fourth embodiment of the tool of the present invention.

FIG. 24 is a side elevational view of the fourth embodiment.

FIG. 25 is an end elevational view of the fourth embodiment from the attachment mounting end.

FIG. 26 is a perspective view of an attachment similar to the attachment shown in FIG. 6 and includes several components which allow for adjustment of the components relative to one another.

FIG. 27 is an exploded perspective view of the attachment shown in FIG. 26.

FIG. 28 is a rear elevational view of the attachment shown in FIG. 26.

FIG. 29 is a perspective view of an inflation engaging attachment which may be used with the attachment of FIG. 26 or FIG. 6 for removing an inflation from its shell.

FIG. 30 is an operational view similar to FIG. 9 showing the tool of the fourth embodiment with two of the first attachments mounted thereon in the process of removing a pulsation hose from a rigid pipe or port of milking equipment.

FIG. 31 is a side elevational view of the fourth embodiment of the tool in the inflation removing configuration positioned prior to removing the inflation from its shell.

FIG. 31A is a sectional view taken on line 31A-31A of FIG. 31.

FIG. 32 is similar to FIG. 31 and shows the hand tool removing the inflation from its shell.

### DETAILED DESCRIPTION OF THE INVENTION

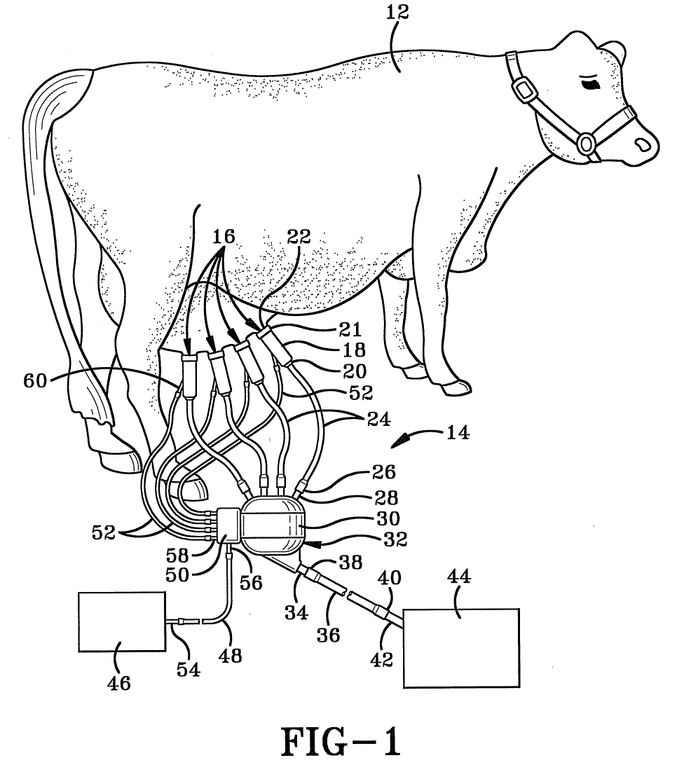

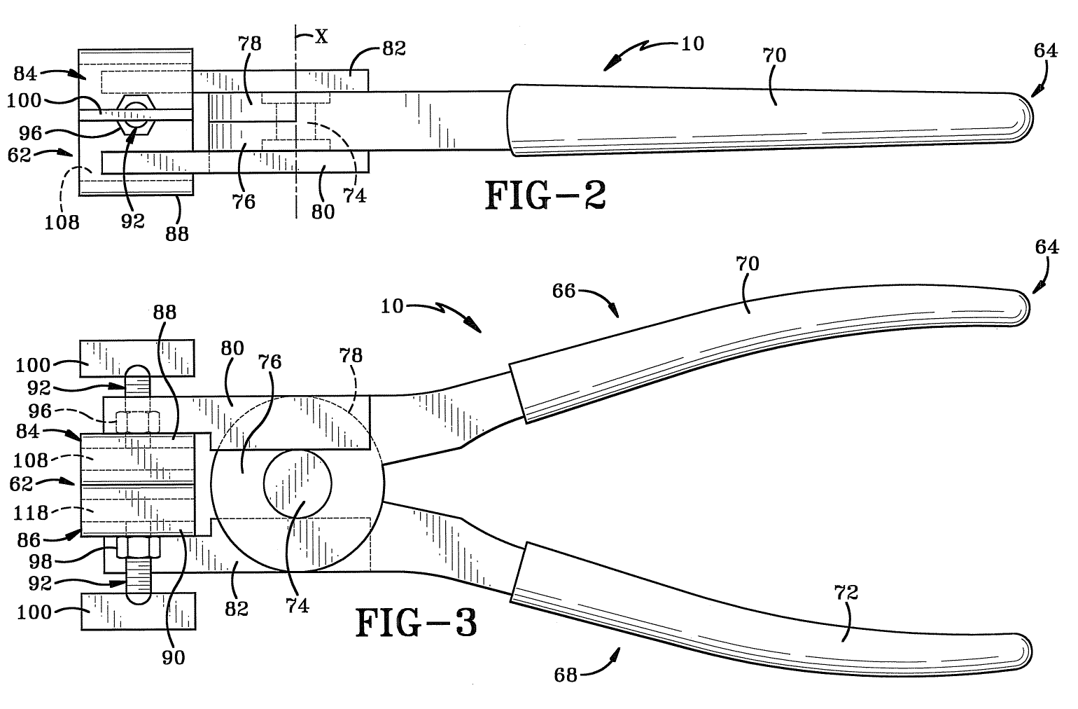

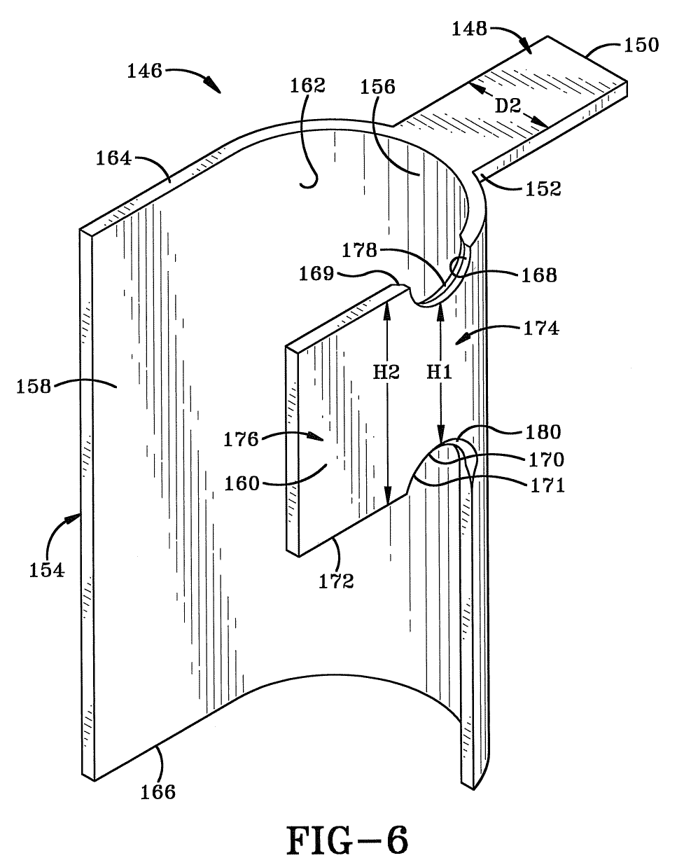

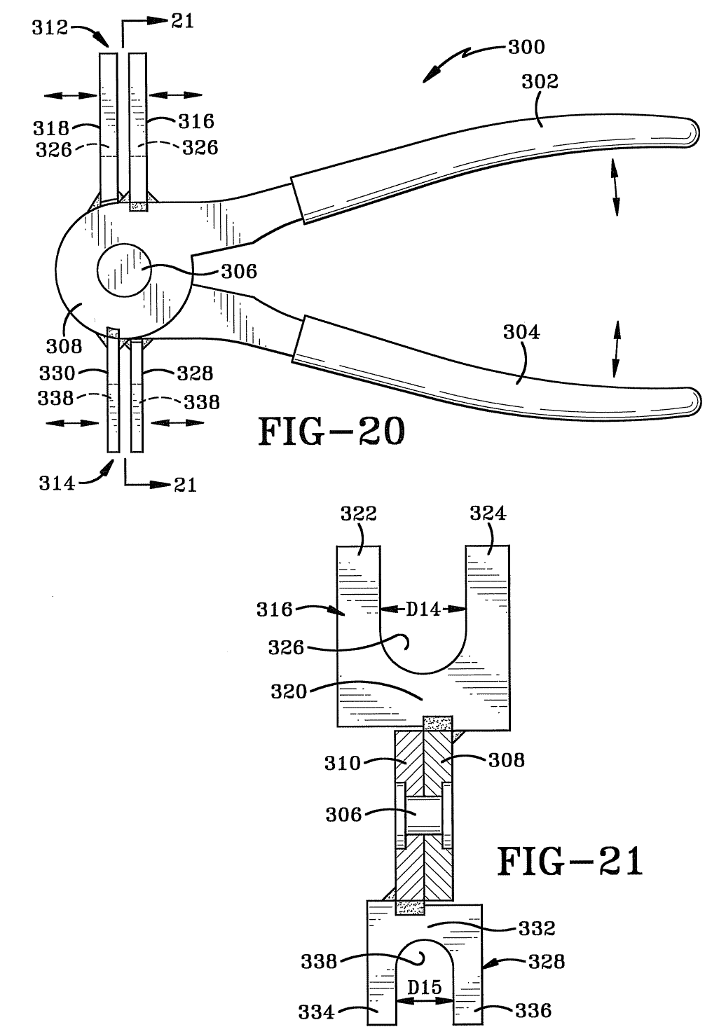

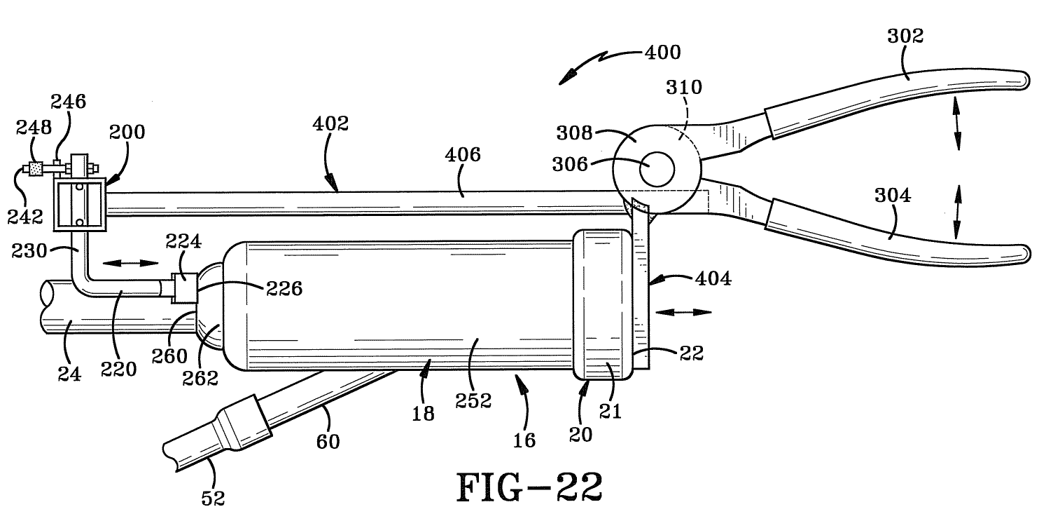

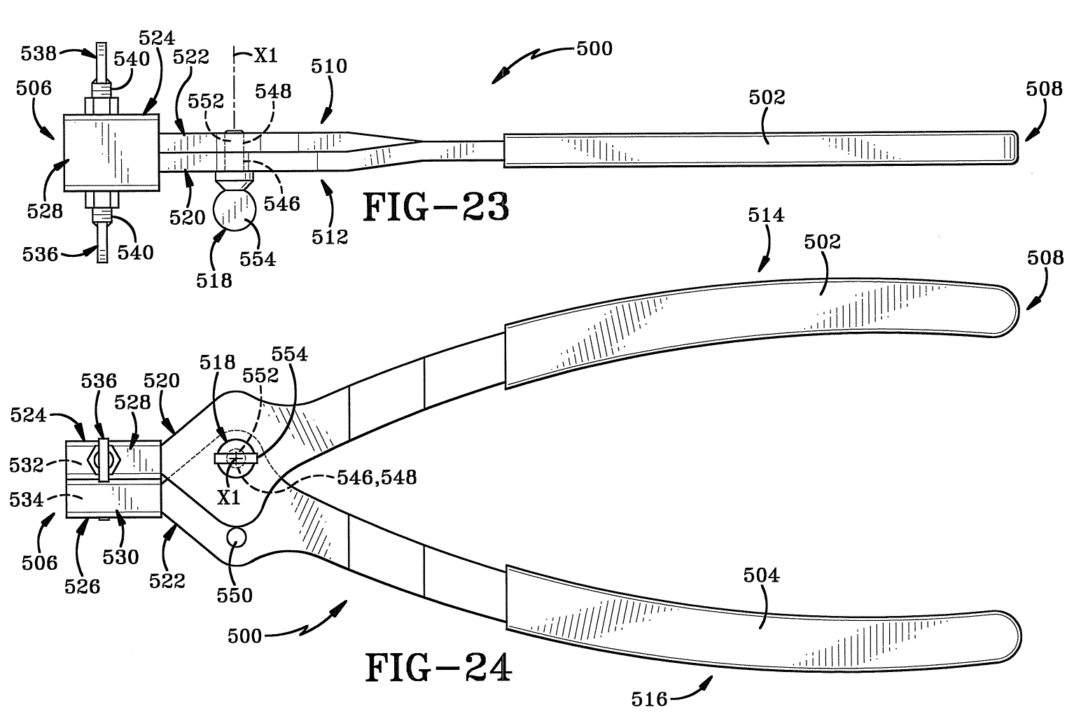

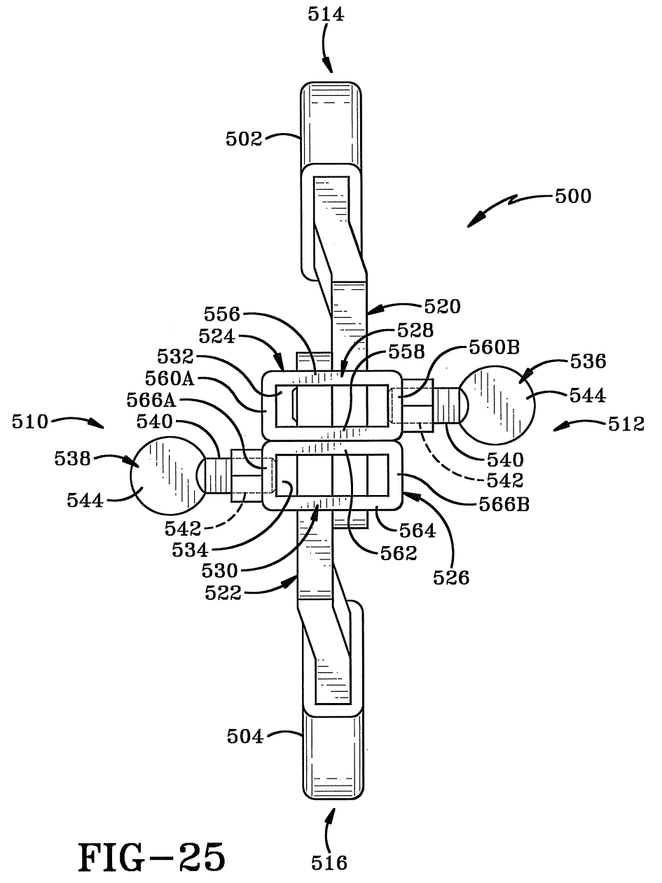

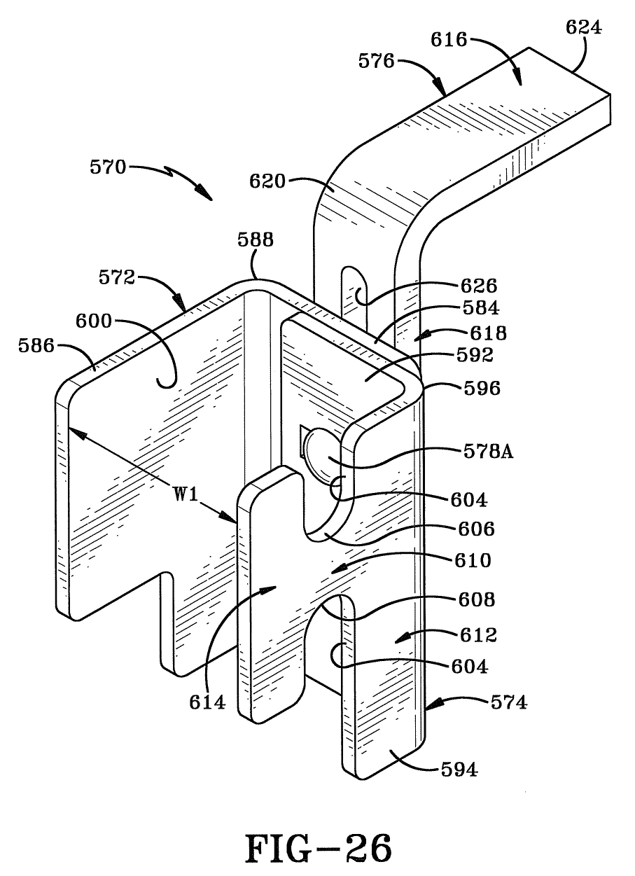

A first embodiment of the present invention is indicated generally at 10 in FIGS. 2-4 and is used with the attachments shown in FIGS. 5-7; a second embodiment of the tool is indicated generally at 300 in FIGS. 20-21; a third embodiment of the tool is indicated generally at 400 in FIG. 22; and a fourth embodiment of the tool is indicated at generally at 500 in FIGS. 23-24. Tools 10 and 500 are used with the various attachments shown in FIGS. 5-7 and 26-29 to remove rubber or elastomeric tubes from the milking equipment shown in FIG. 1, and to remove and install the inflation of the milking equipment from its outer shell, as further described below. Tool 300 is used for removing different sized tubes from the milking equipment and tool 400 is used for removing the inflation from its outer shell.

Referring to FIG. 1, a description is first given of the milking equipment with which the tools of the present invention are used. FIG. 1 shows a cow 12 and milking equipment 14 used for milking the cow. Equipment 14 is shown somewhat diagrammatically to facilitate the description. Four teat cup assemblies 16 are provided to receive and connect to the teats of cow 12. Each assembly 16 includes a rigid outer shell 18 which is typically formed of metal and an inflation 20 a portion of which is disposed within shell 18. Inflation 20 has a first end 22 which extends outwardly from within shell 18 and defines a receiving cup 21 in which the teat of the cow is received. Inflation 20 is formed of rubber or an elastomeric material and has a tubular structure which thus defines a through passage. Inflation 20 typically includes an inflation hose 24 which is most typically formed integrally with cup 21. Hose 24 has a second end 26 adjacent which hose 24 is connected to a rigid inlet port 28 which is received therein and which extends outwardly from a chamber 30 of a quarter milker 32. A rigid outlet port 34 extends outwardly from chamber 30 and has a larger diameter than inlet ports 28. An elastometric tubular milk hose 36 at a first end 38 thereof is mounted on outlet port 34 and thus is of a larger diameter than that of inflation hoses 24. Milk hose 36 at a second end 40 thereof is mounted on an inlet port 42 of a milk collection unit 44. Unit 44 may have a variety of configurations and includes a vacuum mechanism to provide a continuous vacuum within inflations 20 via the through passages of hose 36 and quarter milker 32. A pulsating mechanism or pulsator 46 is provided to provide intermittent or pulsating suction within outer shells 18 on the outside of cups 21 of inflations 20 in order to provide a milking action to the cow's teats. Pulsator 46 communicates with shells 18 via a tubular rubber or elastomeric main pulsation line or hose 48, a pulsation divider 50 and four tubular rubber or elastomeric pulsation branch hoses 52. Main pulsation hose 48 is connected at one end thereof to a rigid main pulsation outlet port 54 on pulsator 46 and at its second end to a rigid pulsation inlet port 56 of divider 50. Each pulsation branch hose 52 is connected at one end to a respective rigid pulsation outlet port 58 on divider 50 and at another end to a respective rigid pulsation inlet port 60 extending outwardly from each shell 18.

Referring to FIGS. 2-4, tool 10 is now described. Tool 10 has first and second opposed ends 62 and 64 and defining therebetween a longitudinal direction. For purposes of facilitating the description, tool 10 has a top 66 and bottom 68. Tool 10 includes rigid upper and lower handles 70 and 72 which are pivotally connected to one another via a pivot 74. Handles 70 and 72 are thus pivotable about an axis X which passes through pivot 74 and defines an axial direction of tool 10. Handle 70 includes a rigid first hub portion 76 from which the elongated arm of handle 70 extends toward second end 64. Likewise, handle 72 includes a rigid second hub portion 78 from which the elongated arm of handle 72 extends toward second end 64. Rigid upper and lower arms 80 and 82 are respectively mounted on hub portions 76 and 78 and extend longitudinally outwardly therefrom toward first end 62 and thus generally in the opposite direction from handles 70 and 72. Upper and lower attachment mounts 84 and 86 are secured to respective free ends of arms 82 and 84 and are used for mounting the attachments described further below and shown in FIGS. 5-7. Upper and lower attachment mounts 84 and 86 respectively include rigid upper and lower channel members 88 and 90. Upper and lower screws 92 and 94 respectively threadedly engage upper and lower nuts or internally threaded structures 96 and 98 which are rigidly mounted on channel members 88 and 90. Each screw 92 and 94 is rotatable as shown at Arrows A in FIG. 4 to move up and down as shown at Arrows B in FIG. 4. Each of screws 92 and 94 includes a threaded rod with manually operable finger lever 100 which provides suitable leverage to manually tighten and loosen screws 92 and 94.

Upper channel member 88 has a substantially rectangular cross-sectional configuration which includes upper and lower substantially flat parallel walls 102 and 104. Member 88 further includes spaced sidewalls 106A and B extending between and connected to upper and lower walls 102 and 104 so that walls 102, 104 and 106 define therebetween a substantially rectangular receiver opening or channel 108. A through hole 110 is formed in upper wall 102 for receiving the lower end of the threaded rod of screw 92. Hole 110 is shown as being unthreaded here although nut 96 may be eliminated and hole 10 may be threaded to threadedly engage screw 92. Lower channel number 90 has a similar rectangular cross-sectional configuration and includes upper and lower substantially flat and parallel walls 112 and 114 with a pair of sidewalls 116A and B connected to and extending therebetween. Walls 112, 114 and 116 define therewithin a lower receiving opening or channel 118 which is substantially rectangular. A through hole 120 is formed in lower wall 114 for receiving therethrough an upper portion of screw 94. Like hole 110, hole 120 is shown as being unthreaded although it may be threaded to threadedly engage screw 94 with or without the use of nut 98. FIG. 4 shows the respective ends of screws 92 and 94 extending respectively a short distance into channels 108 and 118. The inner surfaces of sidewalls 106A and B define therebetween a distance D1 as do the inner surfaces of sidewalls 116A and B.

Referring to FIG. 5, a rigid first attachment 122 which is used with tool 10 is described. Attachment 122 includes a substantially flat rectangular mounting tab 124 configured to be received within one of channels 108 and 118 and engaged by one of screws 92 and 94 when tightened to secure attachment 122 within the respective channel. Attachment 122 has an engaging portion 126 connected to tab 124. Attachment 122 has a first and second opposed ends 128 and 130, with end 128 serving as an insertion end of tab 124 which is inserted into one of channels 108 and 118. Attachment 122 has opposed upper and lower surfaces 132 and 134 and opposed sides 136A and B extending therebetween. Sides 136A and B define therebetween a normal distance D2 which is preferably only slightly less than distance D1 so that tab 124 is easily slid into one of channels 108 and 118 with sides 136A and 136B closely adjacent the inner surfaces of the sidewalls 106 or 116 so the engagement therebetween limits rotational movement of attachment 122 relative to whichever channel member it is mounted on. First and second ends 128 and 130 define therebetween a longitudinal direction of attachment 122 which aligns with the longitudinal direction of tool 10 when mounted thereon. Sides 136A and B define therebetween an axial direction of attachment 122 which likewise aligns with the axial direction of tool 10 when mounted thereon.

Engaging portion 126 extends axially outwardly in either direction from tab 124 and longitudinally outwardly from tab 124. Engaging portion 126 includes a pair of spaced longitudinally extending prying arms 138 defining therebetween an open ended slot 140 which opens at end 130. Each arm 138 has an inner surface facing the other and defining therebetween a distance D3. Engaging portion 126 includes a base 137 from which arms 138 extend longitudinally outwardly. Base 137 has an inner surface which bounds slot 140 and is preferably semicircular. Attachment 122 is thus substantially in the form of a two armed fork typically formed of a substantially flat plate. The upper and lower surfaces of engaging portion 126 adjacent inner surfaces 142 and 144 typically serve as the engaging surfaces used for prying as discussed further below. In the exemplary embodiment, attachment 122 is substantially bilaterally symmetrical about a longitudinally extending plane.

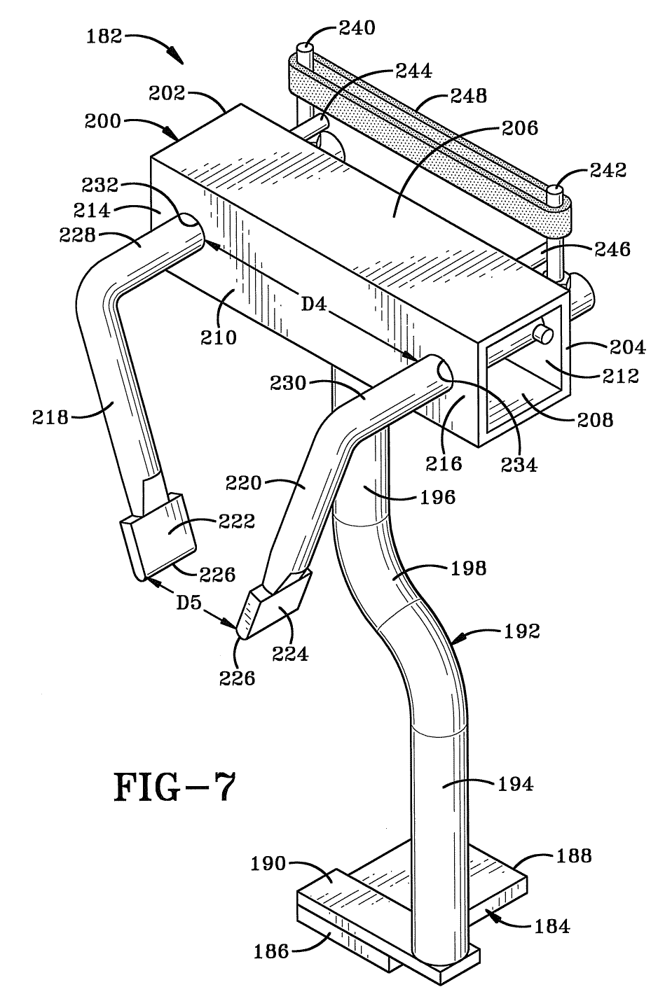

Referring to FIG. 6, a rigid second attachment 146 is described. Attachment 146 includes a mounting tab 148 which is substantially the same as mounting tab 124 and serves the same purpose and is thus not described in detail. Tab 148 has first and second ends 150 and 152 with first end 150 serving as the insertion end of tab 148. Attachment 146 includes an engaging portion 154 connected to a second end 152 of mounting tab 148. The engaging portion has generally U-shaped configuration and may be formed of a single plate of metal or other rigid material. Engaging portion 154 includes a base wall 156 and first and second sidewalls 158 and 160 connected to and extending outwardly therefrom in the longitudinal direction generally opposite tab 148. Base wall 156 at an upper end thereof is connected to second end 152 of tab 148 and in the exemplary embodiment is an arcuate wall which may be semicircular. However, base wall 156 may be flat or of another configuration. Walls 156, 158 and 160 defined therebetween a shell-receiving channel 162 for receiving outer shell 18 of teat cup assembly 16 (FIG. 1). Attachment 146 has a top 164 and a bottom 166 with first sidewall 158 and base wall 156 extending continuously therebetween. Second sidewall 160 is substantially shorter than sidewall 158 and extends outwardly from base wall 156 and defines a portion of top 164.

An upper pulsation port-receiving cutout 168 is formed in second arm 160 and extends downwardly from top 164 adjacent base wall 156. Opposite cutout 168, a lower pulsation port-receiving cutout 170 is formed in second sidewall 160 and extends upwardly from a lower end 172 thereof adjacent base wall 156. An arcuate inner beveled edge or segment 169 of sidewall 160 bounds upper cutout 168, facing generally inwardly and communicating with the inner surface of sidewall 160. An arcuate outer beveled edge or segment 171 bounds lower cutout 170, facing generally outwardly and communicating with the outer surface of sidewall 160.

Second sidewall 160 thus includes a neck portion 174 which extends longitudinally outwardly from base wall 156 and a head portion 176 extending outwardly from neck portion 174. More particularly, sidewall 160 has an upwardly facing surface 178 at the bottom of upper cutout 168 and a downwardly facing surface 180 at the top of lower cutout 170 defining therebetween a height H1 of neck portion 174. Head portion 176 has height H2 defined between top 164 and lower end 172 wherein height H2 is greater than the height H1. Neck portion 174 thus extends longitudinally outwardly from base wall 156 with an upper portion of head portion 176 extending upwardly therefrom adjacent upper cutout 168 to top 164. Likewise, a lower portion of head portion 176 extends downwardly from neck portion 174 adjacent lower cutout 170 to lower end 172.

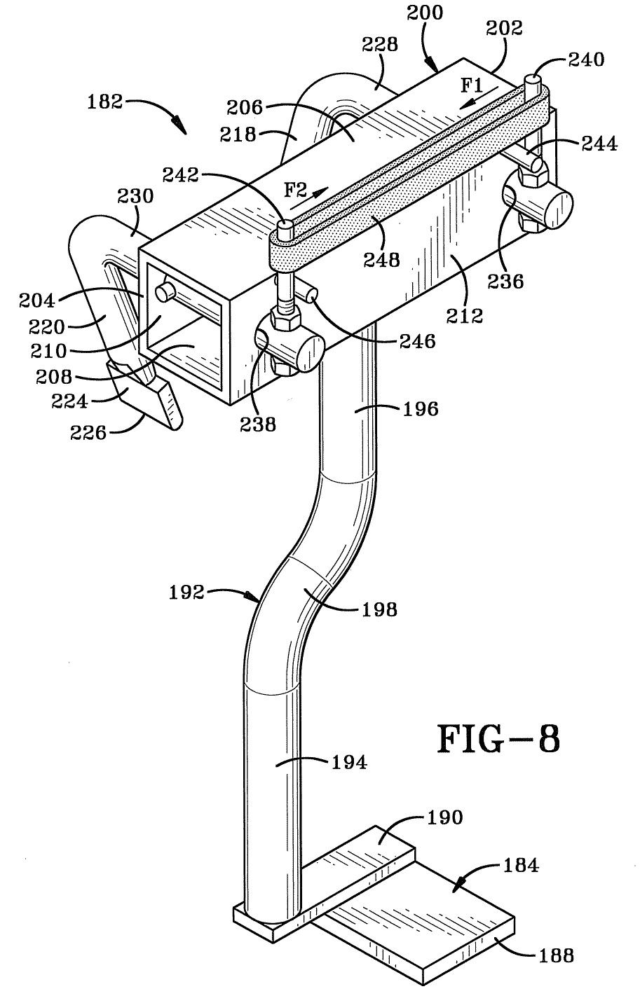

Referring to FIGS. 7 and 8, a third attachment 182 for use with tool 10 is described. Attachment 182 includes a mounting tab 184 and is substantially the same as the other mounting tabs. Tab 184 has a front end 186 and a rear end 188 defining therebetween longitudinal direction of attachment 182 which is aligned with and longitudinal direction of tool 10. Thus, FIG. 7 generally shows the front side of attachment 182 and FIG. 8 generally shows the rear side thereof. A mounting arm 190 is connected to extends axially outwardly from tab 184 adjacent front end 186. An extension arm 192 is connected to and extends upwardly from mounting arm 190. Arm 192 is thus connected to mounting arm 190 at a location which is axially offset from tab 184. More particularly, extension arm 192 includes a lower segment 194 which is connected to mounting arm 190 and extends generally perpendicularly upwardly therefrom. Arm 192 also includes an upper segment 196 which is substantially parallel to lower segment 194. An intermediate segment 198 is connected to the upper end of lower segment 194 and angled relative thereto to connect to the lower end of upper segment 196. A head 200 is connected adjacent the top of upper segment 196 to form a T-shaped configuration therewith. The combination of head 200, arms 190 and 192 and mounting tab 184 form a substantially rigid structure having rigid connections between the respective elements.

Head 200 is shown in the exemplary embodiment as a tubular structure having a substantially square cross-section although it may have any suitable configuration and may be solid. Head 200 has first and second ends 202 and 204 disposed axially outwardly from upper segment 96 in opposite directions. Head 200 includes a top wall 206, a bottom wall 208, a front wall 210 and a rear wall 212 bounding a hollow interior. A first segment 214 of head 200 extends axially outwardly from the top of upper segment 196 to first end 202 and a second segment 216 extend axially outwardly in the opposite direction from upper segment 196 to second end 204. Head 200 thus extends transversely to upper segment 196 in a substantially perpendicular direction.

With continued reference to FIGS. 7 and 8, attachment 182 includes first and second rigid fingers 218 and 220 which are mounted on head 200 and extend generally downwardly therefrom. Fingers 218 and 220 include respective paddles or paddle-shaped fingertips 222 and 224 defining terminal ends 226 thereof. Fingers 218 and 220 angle inwardly from upper ends thereof towards paddles 222 and 224 so that said paddles are spaced from one another. More particularly, fingers 218 and 220 are pivotally mounted on head 200 via connection at their upper end to respective first and second rigid pivots 228 and 230. Pivots 228 and 230 extend substantially perpendicular to fingers 218 and 220. Pivots 228 and 230 are spaced from one another by a distance D4 which is greater than a distance D5 defined between paddles 222 and 224. Pivots 228 and 230 extend respectively first and second front holes 232 and 234 formed in front wall 210 respectively adjacent ends 202 and 204. Likewise, pivots 228 and 230 extend through first and second rear holes 236 and 238 (FIG. 8) formed in rear wall 212 respectively adjacent first and second ends 202 and 204. First and second rigid levers 240 and 242 are connected respectively to pivots 228 and 230 adjacent rear ends thereof behind and adjacent rear wall 212 and extend upwardly therefrom. Each of the levers shown includes a threaded section which extends through a hole formed in a respective pivot whereby two nuts on either side of the pivot threadedly engage the threaded section to the mount the lever on the pivot. However, levers 240 and 242 may be connected in any suitable manner. Levers 240 and 242 extend generally parallel to one another in the exemplary embodiment although this may vary. First and second stops 244 and 246 are connected to and extend rearwardly from rear wall 212 respectively adjacent and between levers 240 and 242 for limiting the inward pivotal movement thereof. Stops 244 and 246 thus serve to limit the outward pivotal movement of paddles 222 and 224 relative to one another to set the distance D5 therebetween. Levers 240 and 242 are spring-biased toward one another so that paddles 222 and 224 are spring-biased away from one another to the set position of FIG. 7. In the exemplary embodiment, this is accomplished through a spring member in the form of a rubber band 248 connected to and circumscribing levers 240 and 242 which applies inward forces F1 and F2 respectively to levers 240 and 242 to move them toward one another and into engagement respectively with stops 244 and 246.

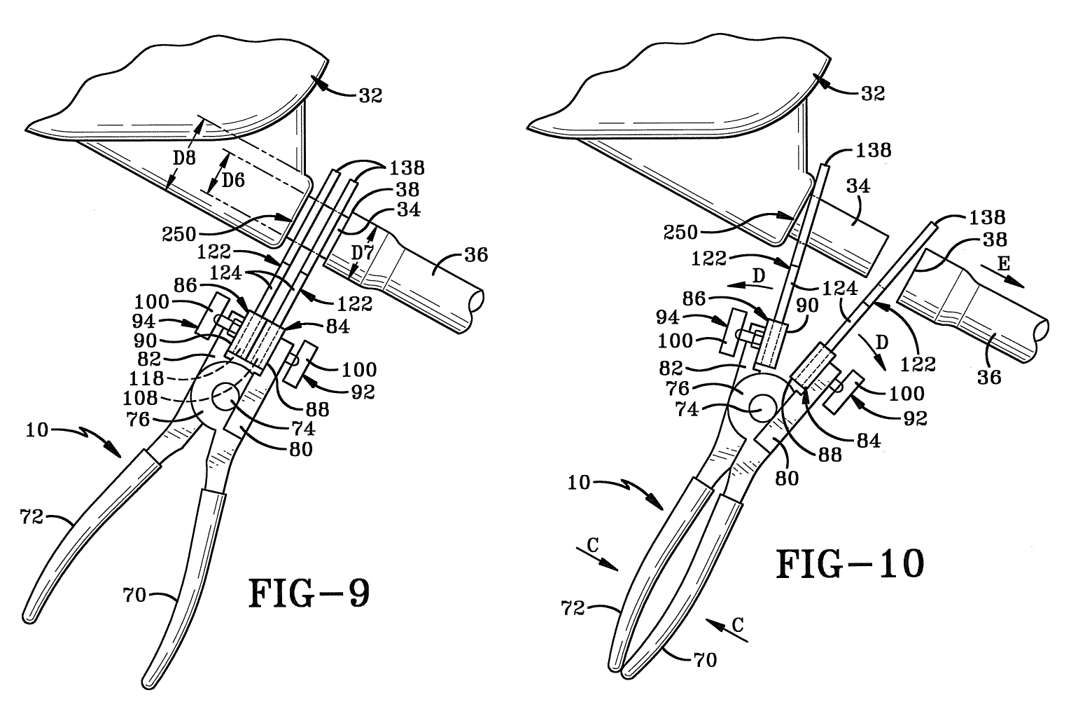

The operation of tool 10 in general and with the various attachments is described with reference to FIGS. 9-19. First, the operation of tool 10 in a hose-removing configuration is described with reference to FIGS. 9 and 10. In general, tool 10 is moveable between an inactivated position shown in FIG. 9 and an activated position shown in FIG. 10. In the inactivated position of FIG. 9, handles 70 and 72 are spread apart from one another while channel members 88 and 90 and the associated structure are adjacent or in abutment with one another. During operation, handle 70 and 72 are manually engaged to move them together (Arrow C) as they pivot about pivot 74 so that mounts 84 and 86 pivotally spread apart from one another (Arrows D). Arrows C and D likewise represent the forces at play during this movement.

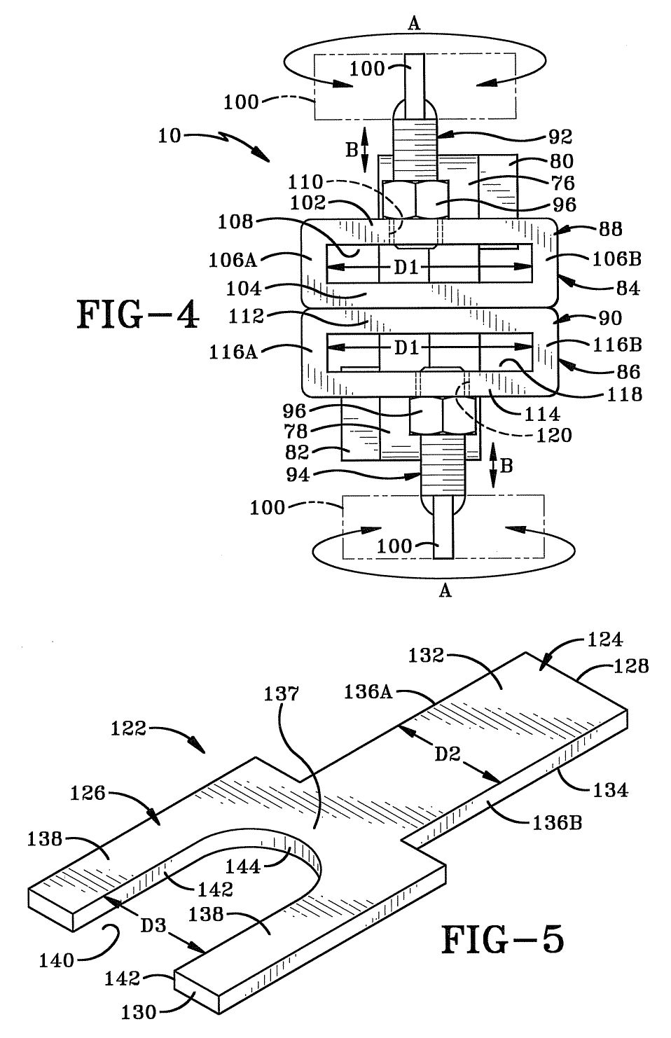

In this hose-removing configuration of tool 10, a pair of first attachments 122 are respectively mounted on mounts 84 and 86 with the respective mounting tabs 124 received respectively in channels 108 and 118 of channel members 88 and 90. Finger levers 100 are respectively manually engaged to tighten screws 92 and 94 whereby the tips thereof engage respective upper and lower surfaces 132 and 134 of the two attachments 122 to secure them to tool 10. To operate tool 10 in this configuration, attachments 122 are moved into position so that outlet port 34 is received within the respective aligned slots 140 of attachments 122. Port 34 has a diameter D6 which is slightly less than width D3 (FIG. 3) of slot 140 of attachment 122 so that port 34 is easily received therein. When hose, 36 is mounted on port 34, the end portion of hose 36 receives port 34 therein so that at first end 38, hose 36 has a diameter D7 which is larger than diameter D3. Likewise, quarter milker 32 has port mounting structure 250 from which port 34 extends outwardly and which has a diameter D8 also larger than width D3. Thus, when handles 70 and 72 are squeezed as shown at Arrows C in FIG. 10 to force attachments 122 away from one another as indicated at Arrows D, upper surface 132 of the upper attachment 122 engages structure 250 and lower surface 134 of the lower attachment 122 engages end 38 of tube 36 to pry tube 36 off of port 34 as indicated at Arrow E. While the operation of tool 10 in the hose-removing configuration has been described with reference to the removal of tube 36 from port 34, the same concept applies to the removal the other rubber tubes from the various ports of milking equipment 14. More particularly and with reference to FIG. 1, attachments such as attachments 122 having different width slots 140 may be used to remove hose 48 from either of ports 54 or 56, any of hoses 52 from a respective port 58 or 60 and any of hoses 24 from a respective port 28. While this configuration of tool 10 was conceived with relation to the removal of rubber or elastomeric tubes from various ports of milking equipment 14, tool 10 and its configuration clearly may be used in other environments for the removal of the rubber tubing.

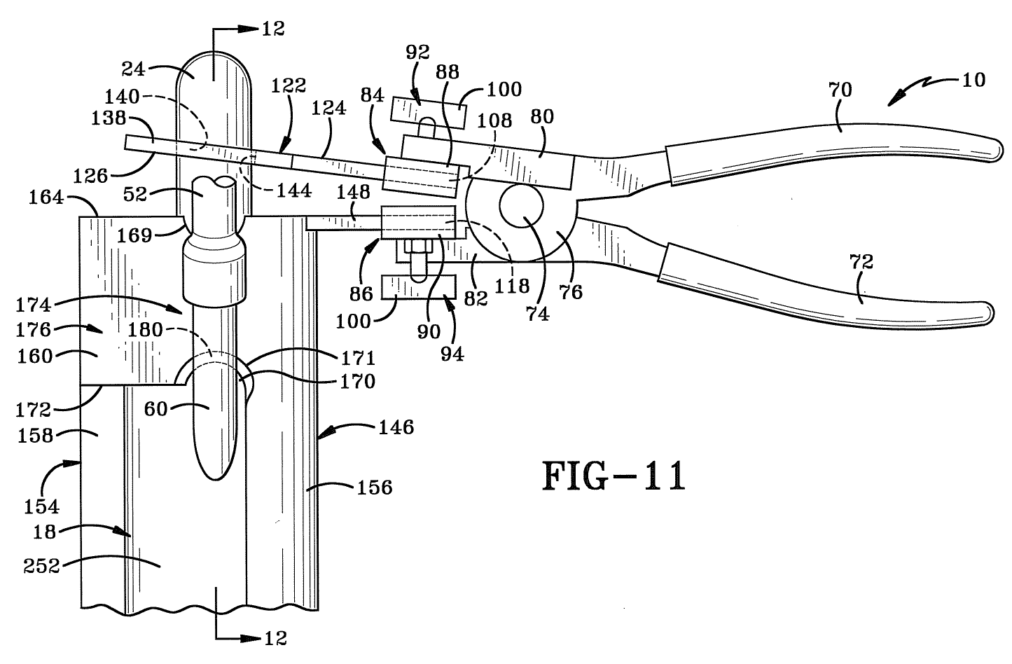

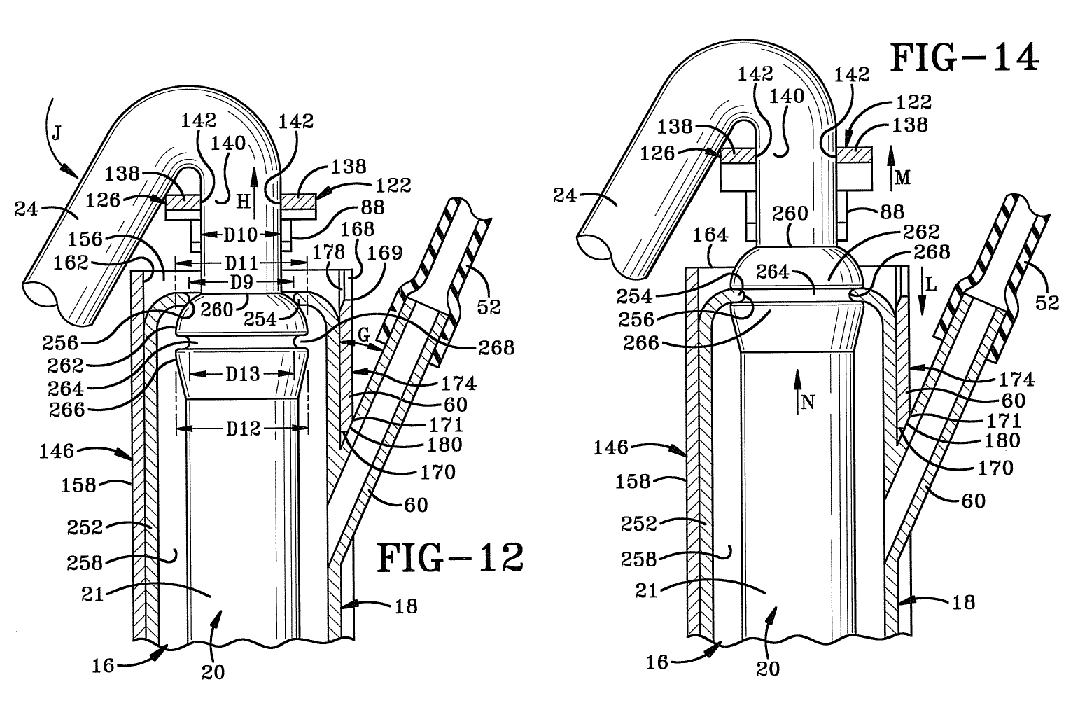

The operation of tool 10 in the inflation-installing or inflation-seating configuration is now described with reference to FIGS. 11-14. In this configuration, first attachment 122 is mounted on upper mount 84 with tab 124 in channel 108. Second attachment 146 is mounted on lower mount 86 with tab 148 secured within lower channel 118. Engaging portion 154 extends downwardly away from first attachment 122 in this configuration. Before further description of the operation of tool 10 in this configuration, teat cup assembly 16 is further described with reference to FIG. 12. Assembly 16 is shown in an inverted orientation relative to that shown in FIG. 1. Outer shell 18 includes an annular sidewall 252 which is generally cylindrical in shape although it is usually tapered slightly so that one end of shell 18 has a diameter slightly larger than the other end. Adjacent one end of shell 18, sidewall 252 includes an inwardly extending annular lip 254 defining a circular hole 256 which has a diameter D9 and communicates with an interior chamber 258 defined within sidewall 252. Port 60 is connected to sidewall 252 and extends outwardly therefrom to define an acute angle G therebetween which is usually less than 45 degrees and typically on the order of about 25-30 degrees.

Port 60 has an interior passage which communicates with interior chamber 258.

Cup 21 of inflation 20 has an inflation hose end 260 from which hose 24 extends outwardly. Adjacent end 260, cup 21 extends radially outwardly from its connection to hose 24 to a first annular shoulder 262. Cup 21 then extends inwardly from first shoulder 262 to annular neck 264 and then outwardly therefrom to a second shoulder 266 so that shoulders 262 and 266 define therebetween an annular groove 268 bounded by neck 264. Hose 24 has a diameter D10 which is smaller than diameter D9. First and second shoulders 262 and 266 have respective diameters D11 and D12 each of which is larger than diameter D9 and each of which is typically about the same as the other. Neck 264 has a diameter D13 which is approximately the same as diameter D9.

The operation of tool 10 in the inflation-installing configuration now continues with continued reference to FIGS. 11-14. FIGS. 11 and 12 show outer shell 18 received within channel 162 of engaging portion 154 of second attachment 146. Sidewall 252 is positioned closely adjacent or in abutment with sidewalls 158 and 160 and base wall 156. Neck portion 174 of sidewall 160 is positioned directly between sidewall 252 and port 60 within the area defining acute angle G. Beveled edge 171 abuts port 60 with neck portion along edge 171 wedged between port 60 and sidewall 252.

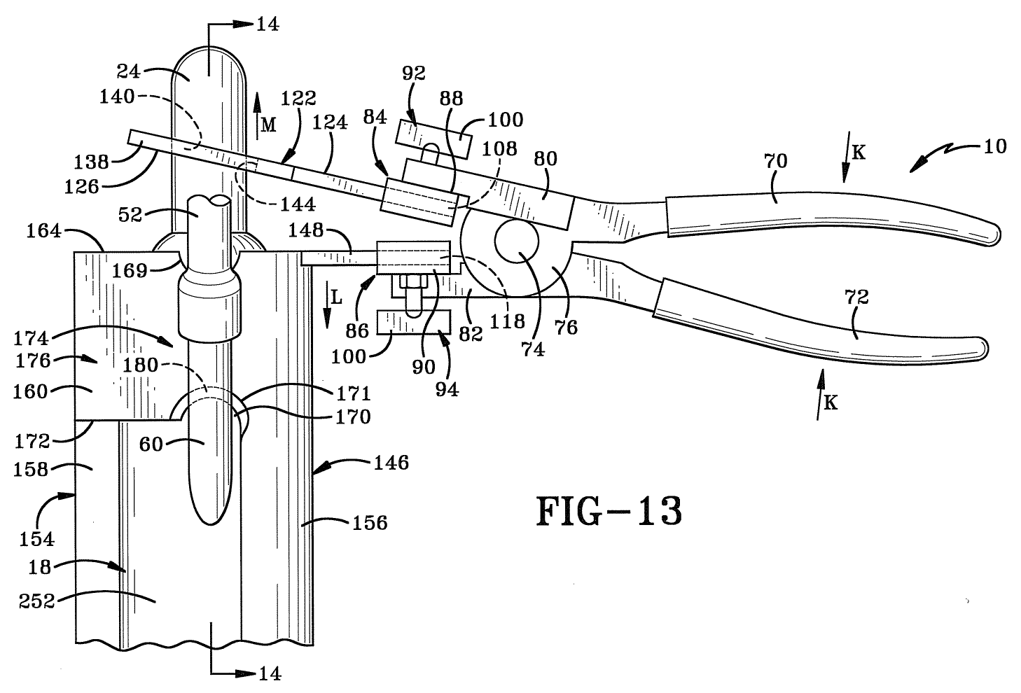

At the stage shown in FIGS. 11 and 12, inflation hose 24 has been inserted through the end of outer shell 18 opposite lip 254 and through hole 256 (Arrow H) so that cup 21 is received within the interior chamber 258 and cup 21 adjacent shoulder 262 abuts lip 254. Hose 24 is then folded or bent over one of arms 138 as indicated at Arrow J in order to provide a firm frictional engagement between hose 24 and said arm 138. Handles 70 and 72 are then squeezed to move toward one another as indicated at Arrows K in FIG. 13 so that neck 174 at beveled edge 171 applies a downward force to the top of port 60 (Arrows L) and arm 138 of attachment 122 over which hose 24 is bent applies an upward force to hose 24 as indicated at Arrows M. The forces shown at Arrows L and M thus causes a radially inward force from lip 254 on shoulder 262, causing shoulder 262 to be forced inwardly and allow it to pop through hole 256 so that lip 254 is seated within groove 268 abutting neck 264, the lower surface of shoulder 262 and the upper surface of shoulder 266 to provide a seal therebetween. Simultaneously, a collar portion of cup 21 adjacent end 22 (FIGS. 1 and 22) is moved into a sealing position with the opposite end of outer shell 18. During the seating of lip 254 within groove 264, hose 24 is manually held in the bent over position. It is noted that in order to achieve this operation that hose 24 need not be inserted through a slot such as slot 140. Thus, a simple attachment with a single outwardly extending arm such as arm 138 may be used for this purpose. In addition, other configurations for an attachment may be used in which the attachment provides a clamping engagement with hose 24 as opposed to the simple frictional engagement provided by manually bending the hose over. However, bending the hose over a simple arm is effective, quick and the attachment is less expensive than those which would be more complicated. The use of attachment 122 provides for dual usage in the hose-removing configuration and inflation-installing configuration.

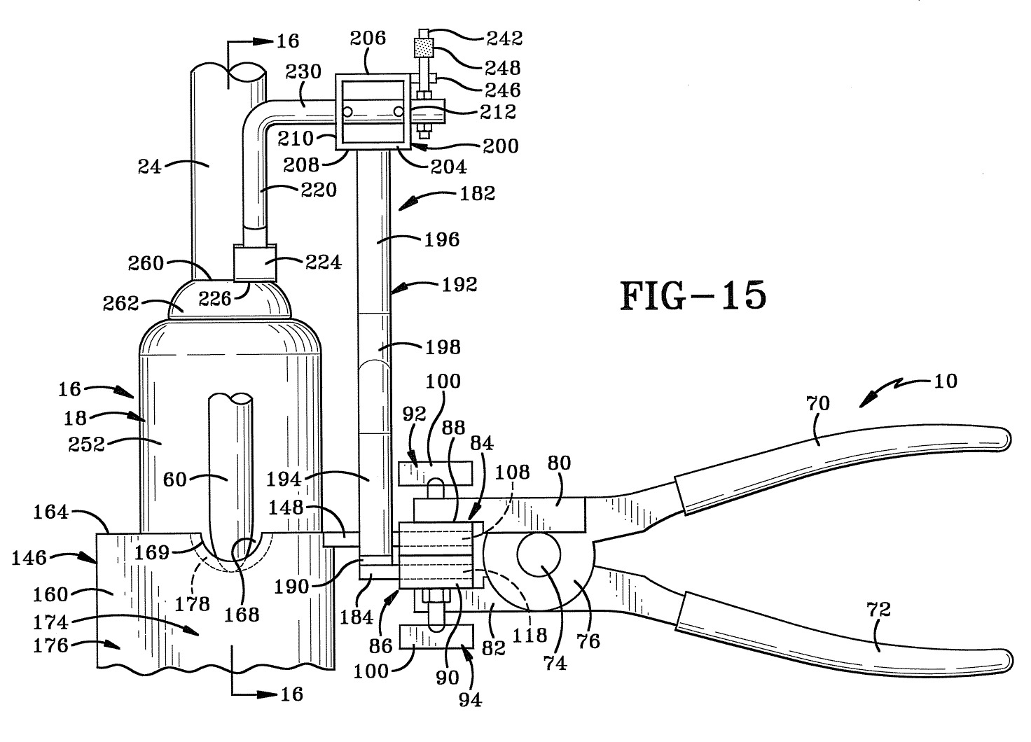

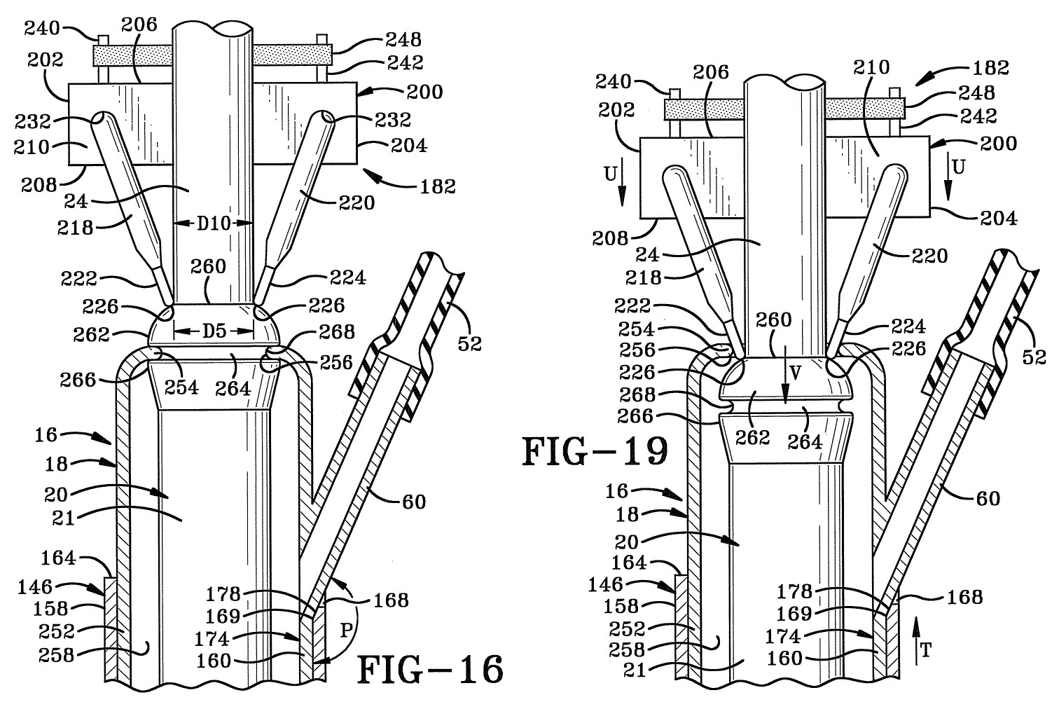

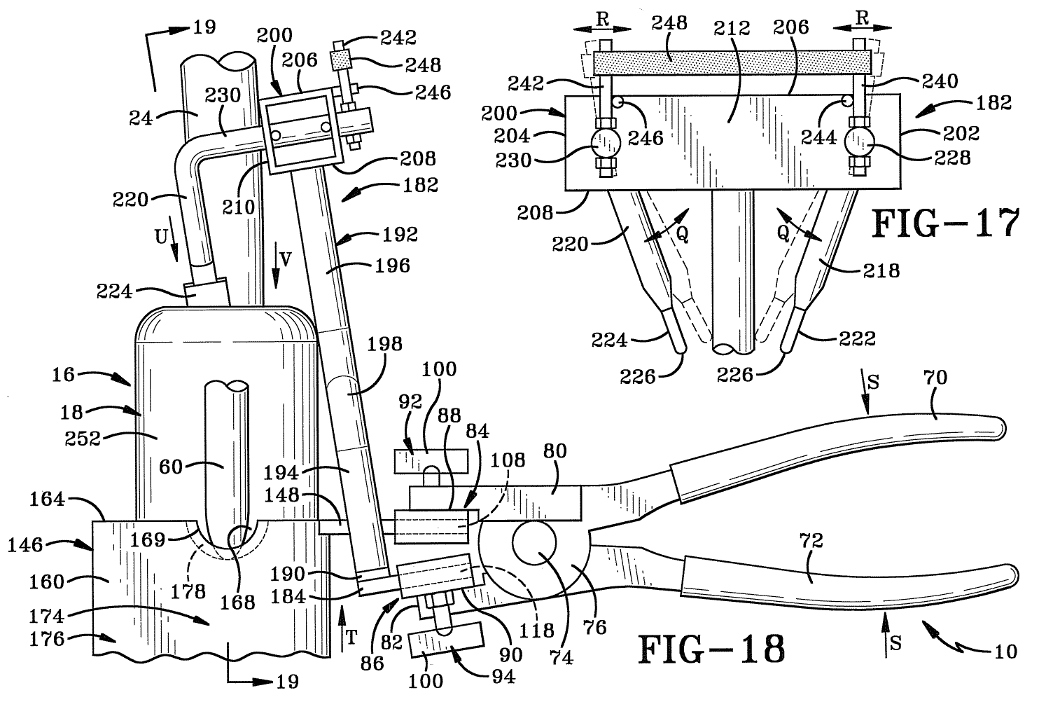

The operation of tool 10 in the inflation-removing configuration is now described with reference to FIGS. 15-19. The removable nature of the attachments of the invention allow for tool 10 to be quickly and easily changed between the various configurations. In the inflation-removing configuration shown in FIG. 15, attachment 146 is used in conjunction with attachment 182. However, instead of attachment 146 being mounted on lower mount 86, it is now mounted on upper mount 84 with tab 148 thereof in channel 108. Engaging portion 154 extends downwardly past mount 86. The fact that arm 190 extends axially outward of tab 184 allows lower segment 194 of extension arm 192 to be offset axially outwardly from tab 124 of second attachment 146 while the configuration of arm 192 allows upper segment 196 to be aligned substantially centrally directly above tab 124 in order to provide a downward force during operation which is substantially aligned with hose 24. As shown in FIGS. 15 and 16, outer shell 18 is again received within channel 162 of attachment 146. However, a portion of shell 18 from lip 254 generally to around port 60 extends upwardly of top 164 and thus is external to channel 162. Port 60 is received within upper cutout 168 with beveled edge 169 in abutment with the lower portion of port 60. More particularly, port 60 and the portion of shell 18 therebelow define therebetween an obtuse angle P which is typically greater than 135 degrees in accordance with the previous discussion of angle G (FIG. 12). Due to angle P, first sidewall 158 engages shell 18 opposite wall 160 in order to ensure that wall 160 is able to engage port 60 without slipping off during upward force relative to port 60. Terminal ends 226 of fingertips 222 and 224 engage shoulder 262 adjacent its connection to hose 24 at end 260 on opposite sides of hose 24. Referring to FIG. 16, it can now be seen that distance D5 between fingertips 222 and 224 is approximately the same as diameter D10 of hose 24 although this may vary somewhat due in part to the flexible nature of hose 24. The use of stops 244 and 246 (FIG. 8) prevents the fingertips 222 and 224 from moving further outwardly as previously noted. However, the pivotal mounting of fingers 218 and 220 allows for them to pivot inwardly from the position shown in FIG. 16, as indicated by Arrows Q in FIG. 17, as levers 240 and 242 are likewise able to pivot outwardly a limited distance from their positions in engagement with stops 244 and 246, as indicated at Arrows R in FIG. 17.

When handles 70 and 72 are squeezed together as indicated at Arrows S in FIG. 18, attachment 146 moves upwardly (Arrows T) to apply an upward force on port 60 and attachment 182 moves downwardly (Arrows U) so that fingertips 222 and 224 apply a downward force atop shoulder 262 to force it through hole 256, thus unseating lip 254 from within groove 268, as indicated at Arrows V. More particularly, fingertips 222 and 224 simultaneously apply an inward force toward one another on shoulder 262 and hose 24 adjacent its connection at 260 to facilitate the deformation of shoulder 262 so that it is more easily forced through hole 256. The ability of fingertips 222 and 224 to pivot toward one another to overcome the spring tension created by rubber band 248 is provided by the positioning of pivots 228 and 230 at distance D4 from one another which is greater than distance D5 between fingertips 222 and 224, as previously discussed with reference to FIG. 7.

It is noted that in the inflation-removing configuration of tool 10, the two attachments 146 and 182 apply forces toward one another during the removal procedure. This is in opposition to the previous two configurations in which the forces were away from one another. This is the reason that attachment 146 is mounted on upper mount 84 and attachment 182 is mounted on lower mount 86 and also the reason for the offsetting of lower segment 194 of arm 192. Thus, the ability to provide a single tool for removing the inflation, installing the inflation and removing rubber hoses from the various ports is achieved by these various configurations. However, it is noted that the removal of the inflation may likewise be achieved by attachments similar to attachments 146 and 182 which are mounted on mounts of a hand tool similar to tool 10 without having the attachments cross over one another and require such an offset as provided by arm 190 and lower segment 194. That is to say, a hand tool may be provided with mounts or jaws that move toward one another in response to the squeezing of handles 70 and 72 instead spreading away from one another so that attachments similar to 146 and 182 may be mounted in an opposite manner.

Tool 300 is now described with reference to FIGS. 20 and 21. Tool 300 includes first and second handles 302 and 304 which are pivotally connected at a pivot 306 in a manner similar to tool 10. Handle 302 and 304 include respective hub portions 308 and 310. Tool 300 is used for the prying of rubber or elastomeric hoses off of the various ports or the like of milking equipment 14 as in the configuration of tool 10 shown in FIGS. 9 and 10. However, tool 300 has two sets of attachments one of which allows for the removal of a first size hose and the other of which allows for the removal of a second size hose which is of a different size. More particularly, a first set of attachments 312 and second set of attachments 314 are permanently attached to hub portions 308 and 310. First set 312 includes first and second attachment 316 and 318 which are substantially identical to one another and have a configuration which is substantially the same as that of engaging portion 126 of first attachment 122 without tab 124 (FIG. 5). First attachment 316 is rigidly attached to hub portion 308 as by welding or the like and second attachment 316 is likewise attached to second hub portion 310. More particularly, each attachment 316 and 318 has a base 320 which is mounted on the respective hub portion and pair of prying arms 322 and 324 defining therebetween a slot 326 which is analogous to slot 140 of attachment 122. Arms 322 and 324 define therebetween a distance D14 which is the width of slot 326.

Likewise, a second set of attachments 314 includes first and second attachments 328 and 330 which are substantially identical to one another. As shown in FIG. 21, each attachment has a base 322 and a pair of prying arms 334 and 336 defining therebetween a slot 338 having a width D15 defined between arms 334 and 336. Width D15 is smaller than width D14 and thus is suitable for use with a smaller port and rubber hose connected thereto for the removal thereof. First set of attachments 312 and second set of attachments 314 work in substantially the same manner as described with reference to tool 10 when used in the hose-removing configuration shown in FIGS. 9 and 10. Thus, when handles 302 and 304 are squeezed together, attachment 316 and 318 move away from one another as do attachments 328 and 330 in order to provide the prying motion needed to remove the hose from a port as previously described. Attachments 316 and 318 extend generally perpendicular to handles 302 and 304 and attachment 328 and 330 extend generally perpendicular to handles 302 and 304 in a direction opposite attachments 316 and 318. It is noted that each set of attachments may be angled with respect to the handles as desired, as illustrated by sets 312, 314 and also attachments 122 in the configuration of tool 10 in FIGS. 9 and 10. Thus, it is also viable to attach an additional set of attachments for prying to the end of hub portions 308 and 310 generally opposite handle 302 and 304 to provide attachments for removing a different size of tubing from a different size port if desired.

Referring to FIG. 22, tool 400 is now described. Tool 400 is configured for removing inflation 20 from shell 18. The handles and hub portions are the same as tool 300. First and second attachments 402 and 404 are respectively mounted on hub portions 310 and 308. First attachment 402 is similar to attachment 182 except it has an extension arm 406 which is longer than its corresponding counterpart and is connected directly to hub portion 310. Arm 406 may be substantially straight although it may also have some angles or curves in it to provide for some offset as previously described with regard to attachment 182. Arm 406 extends generally parallel to handles 302 and 304 and second attachment 404 extends substantially perpendicular to arm 406. Attachment 404 may simply be a flat plate or any member for suitably engaging end 22 of cup 21 of inflation 20. In operation, the squeezing of handles 302 and 304 together cause attachment 404 and fingertips 222 and 224 to move toward one another in order to operate in substantially the same manner as discussed with the inflation-removal configuration of tool 10. While attachment 404 prevents the removal of cup 21 adjacent end 22 from shell 18 during operation, the flexible nature of inflation 20 nonetheless allows for shoulder 262 to be pushed by fingertips 222 and 224 through hole 256 (FIG. 12) while attachment 404 engages end 22. Once shoulder 262 is pushed through the hole, handles 302 and 304 may be released and inflation 20 may be removed by hand from shell 18.

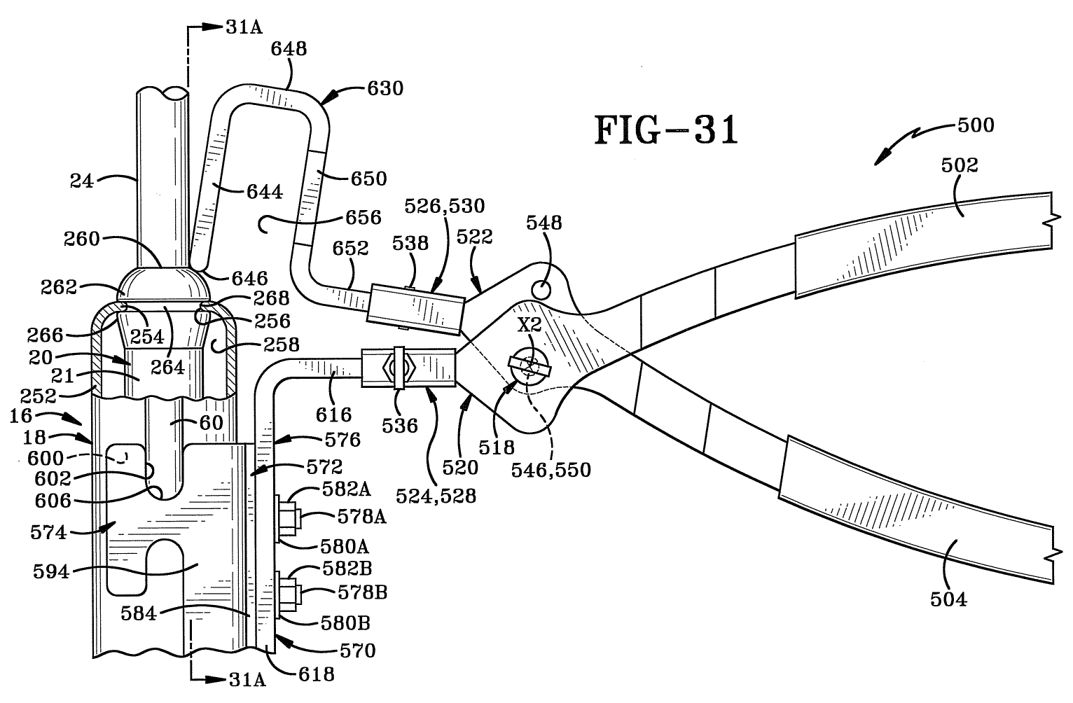

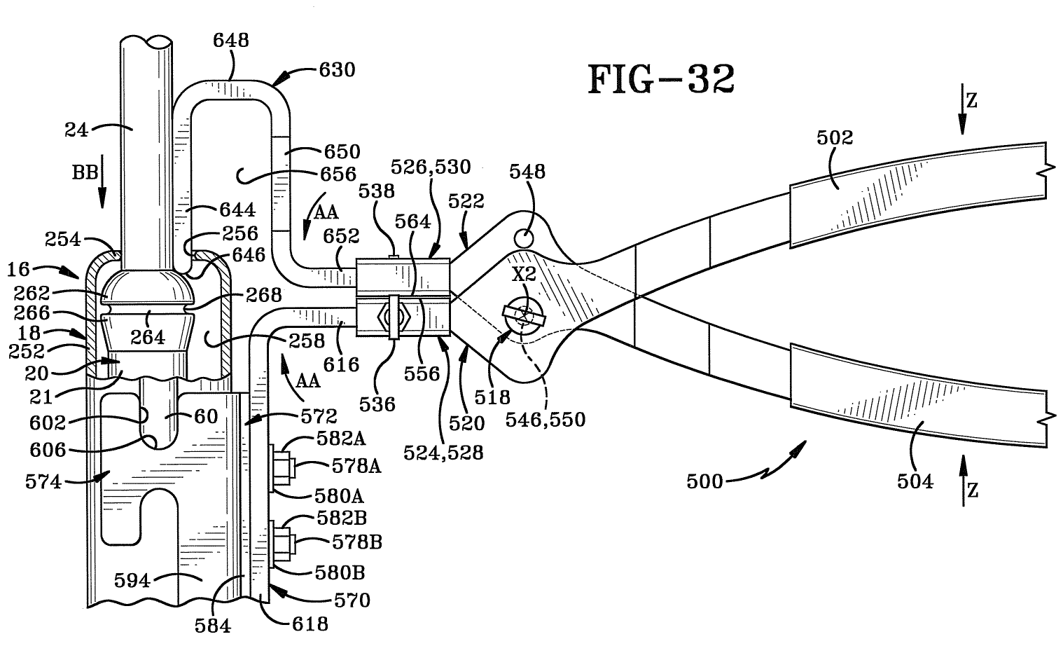

Hand tool 500 and its attachments are now described in greater detail with reference to FIGS. 23-29, beginning with tool 500 with reference to FIGS. 23-25. Hand tool 500 is similar to hand tool 10 and is thus configured for removing and installing rubber or elastomeric components respectively from and onto rigid components, such as found in milking equipment 14 (FIG. 1). However, tool 500 is configured with two different orientations respectively shown in FIGS. 24 and 32. More particularly, upper and lower handles 502 and 504 of tool 500 are pivotally connected to one another to pivot about an axis X1 in the first orientation shown in FIGS. 23 and 24 and alternately in the second orientation of FIGS. 31-32 about an axis X2 which is offset from and parallel to axis X1. The description and operation of tool 500 in the second orientation will be described further below.

Referring now to FIGS. 23-25, tool 500 has a first or front end 506 and a second or back end 508 which generally define therebetween a longitudinal direction of tool 500. Tool 500 further includes first and second opposed sides 510 and 512 defining therebetween an axial direction of the tool, which is the direction in which axes X1 and X2 extend. Tool 500 further has a top or top side 514 and a bottom or bottom side 516. The terminal ends of handles 502 and 504 define back end 508. Handles 502 and 504 are pivotally connected to one another via a pivot 518 through which axis X1 passes in the first orientation. First and second arms 520 and 522 are respectively rigidly and permanently connected to handles 502 and 504 adjacent pivot 518 and extend radially outwardly therefrom generally in a forward direction. Arms 520 and 522 respectively include first and second attachment mounts 524 and 526 which are similar to mounts 84 and 86 of tool 10. Thus, mounts 524 and 526 include respective first and second channel members 528 and 530 defining respective channels 532 and 534 having entrance openings at front end 506 for slidably receiving therein portions of the various attachments which are removably mountable on mounts 524 and 526. Mounting screws 536 and 538 are provided, each including an externally threaded shaft or portion 540 which threadedly engages an internally threaded hole 542 formed in a respective sidewall of channel members 528 and 530. Screws 536 and 538 thus extend outwardly on either side of tool 500 instead of the upward and downward configuration of screws 92 of tool 10. Each of screws 536 and 538 further includes a finger lever 544 secured to the shaft or threaded portion to facilitate the threading and unthreading thereof.

An unthreaded hole 546 is formed in the hub portion or forward end of upper handle 502. Upper and lower internally threaded holes 548 and 550 are formed in the hub portion or forward end of handle 504. Threaded upper hole 548 is aligned with hole 546 in the first orientation of tool 500 shown in FIGS. 23-25 and lower hole 550 is aligned with hole 546 in the second orientation of tool 500 shown in FIGS. 31 and 32. Screw 518 includes an externally threaded portion or shaft 552 which is receivable through unthreaded hole 546 to threadedly engage threaded hole 548 in the first orientation and threaded hole 550 in the second orientation. Screw 518 includes a finger lever 554 to facilitate the threading and unthreading of screw 518 within holes 548 or 550.

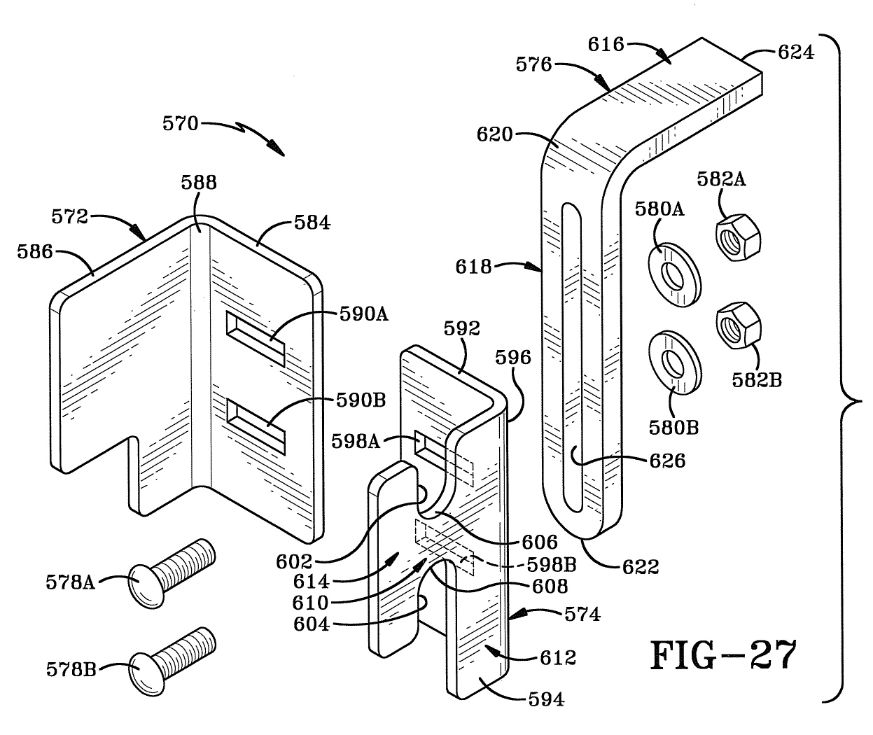

The relative position of channel members 528 and 530 is different in the first orientation of FIGS. 23-25 than the second orientation of FIGS. 31 and 32. In the former orientation, channel member 528 is above second channel member 530 while in the latter orientation these positions are reversed. More particularly, channel member 528 includes flat parallel top and bottom walls 556 and 558 with a pair of spaced sidewalls 560A and B which are connected to and extend between top and bottom walls 556 and 558 so that said walls define the channel 532. Likewise, second channel member 530 includes flat parallel top and bottom walls 562 and 564 with a pair of sidewalls 566A and B connected to and extending perpendicularly to top and bottom walls 562 and 564 so that said walls define therewithin channel 534. In the first orientation shown in FIGS. 23-25, the flat upwardly facing surface of top wall 562 is positioned directly below the flat downwardly facing surface of bottom wall 558 and is typically closely adjacent or in contact therewith when handles 502 and 504 are pivoted to spread away from one another to the maximum degree as illustrated in FIGS. 24 and 25. Channel 532 is thus positioned directly above channel 534.

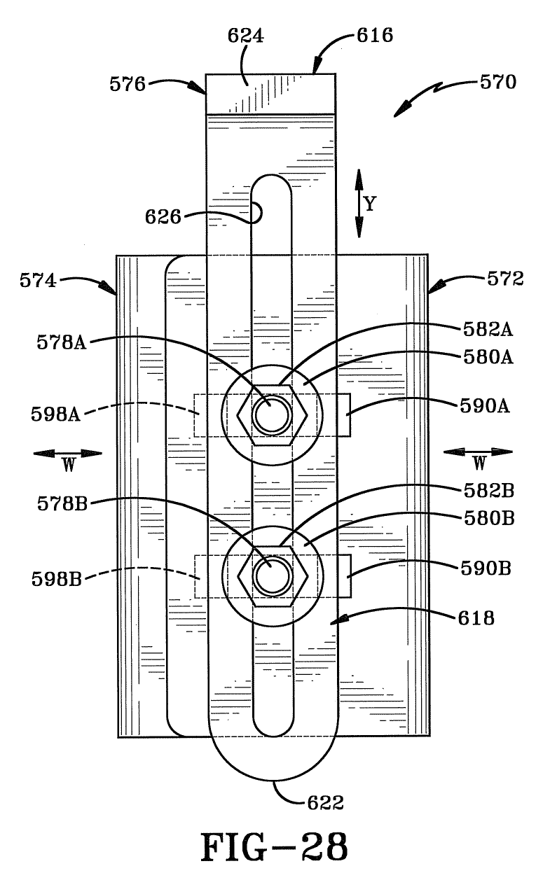

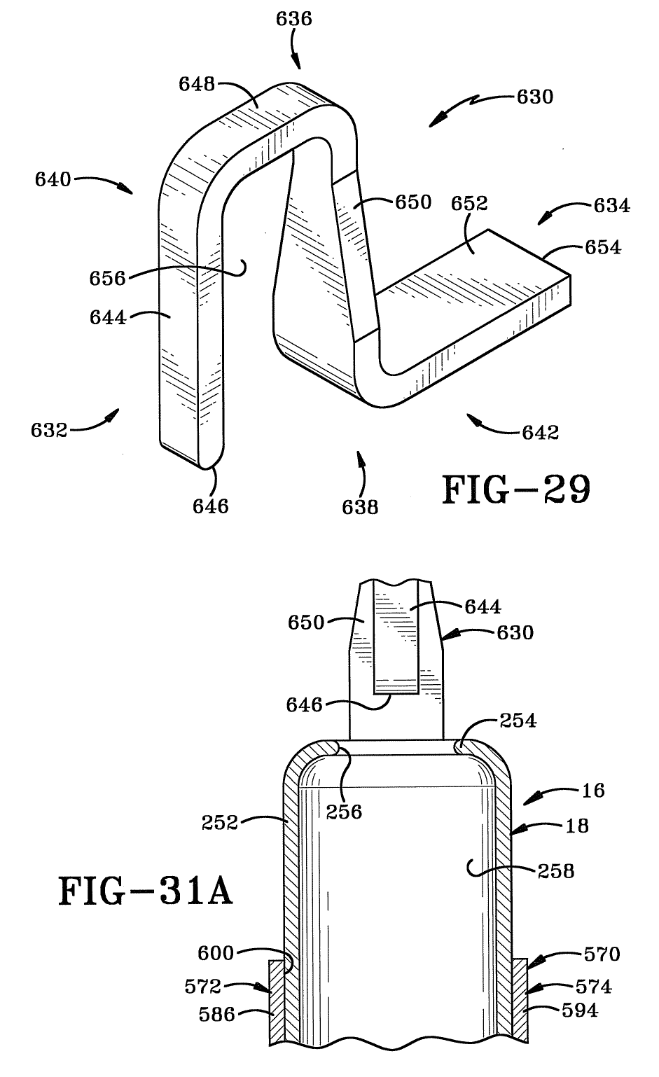

Another attachment in the form of an inflation shell engaging member 570 is now described with reference to FIGS. 26-28. Member 570 is similar to member 146 (FIG. 6) although it includes three primary components in the form of first and second channel-forming members 572 and 574, and a mounting member 576. Member 570 further includes a securing mechanism which is in the exemplary embodiment in the form of a pair of threaded bolts 578A and B, a corresponding pair of washers 580A and B and a corresponding pair of nuts 582A and B which threadedly engage bolts 578A and B respectively to secure members 572, 574 and 576 to one another. Members 572, 574 and 576 are adjustably mounted on one another as will be described in greater detail below. As best shown in FIG. 27, member 572 includes a flat vertical back wall 584 and a flat vertical sidewall 586 which is rigidly connected to back wall 584 at a vertical corner 588 and extends perpendicularly forward therefrom. Back wall 584 thus extends from corner 588 laterally toward member 574. Upper and lower vertically spaced slots 590A and 590B are formed in back wall 584 extending from its front surface to its back surface. Each of slots 590 is elongated in the axial direction, and lower slot 590B is spaced downwardly from and directly below upper slot 590A. Member 572 has an L-shaped configuration as viewed from above.

Member 574 is also L-shaped as viewed from above and includes a flat vertical back wall 592 and a flat vertical sidewall 594 which is connected to back wall 592 at a vertically elongated corner 596 and extends perpendicularly forward therefrom. Back wall 592 thus extends from corner 596 generally toward member 572 when members 572 and 574 are joined together with the securing mechanism. When members 572 and 574 are secured to one another, sidewalls 586 and 594 are axially spaced from one another to define therebetween a shell-receiving channel 600 which is bounded by back walls 584 and 592. Upper and lower vertically spaced slots 598A and 598B are formed in back wall 592 and are substantially identical to slots 598A and B respectively. When members 572 and 574 are joined, back walls 584 and 592 are parallel and abut one another with upper slots 590A and 598A aligned at the same height to receive therethrough screw 578A, and lower slots 590B and 598B aligned at the same height to receive therethrough screw 578B. An upper upwardly opening pulsation port-receiving notch 602 is formed in sidewall 594 in communication with channel 600 and extends downwardly from the top thereof to an upwardly facing pulsation port engaging surface 606. Likewise, a lower downwardly opening pulsation port-receiving notch 604 is formed in sidewall 594 in communication with channel 600 directly below notch 602 and extends upwardly to a downwardly facing pulsation port engaging surface 608. Notches 602 and 604 thus open respectively toward and away from finger 644 of arm 522 with surfaces 606 and 608 respectively facing toward and away from finger 644 of arm 522. Surfaces 606 and 608 define therebetween a neck portion 610 of sidewall 594 which extends forward from a rear portion 612 to a front head portion 614. Like the neck portion 174 and head portion 176 of attachment 146 (FIG. 6), neck portion 610 has a height which is less than that of head portion 614. Head portion 614 includes rearwardly facing surfaces which respectively bound notches 602 and 604 while rear portion 612 likewise defines forward facing surfaces which respectively bound notches 602 and 604.

Mounting member 576 is L-shaped as viewed from the side and includes a mounting tab in the form of a horizontal leg 616 and a vertical leg 618 which is connected to the front of horizontal leg 616 at a horizontal corner 620 and extends downwardly perpendicular thereto to a lower terminal end 622. Leg 616 extends from its front end at corner 620 to a rear terminal back end 624. A vertically elongated slot 626 is formed in vertical leg 618 and extends from adjacent its upper end and corner 620 to adjacent lower end 622. Slot 626 receives therethrough each of bolts 578A and B when members 572, 574, and 576 are secured to one another via screws 578, washers 580 and nuts 582. Thus, respective portions of slot 626 are respectively aligned with portions of slots 590 and slots 598 when member 570 is assembled. Bolts 578 and their respective nuts 582 may thus be unthreaded or loosened to provide an adjusting position which allows the three components 572, 574 and 576 to be adjusted relative to one another and threaded or tightened to a tightened or securing position in which components 572, 574 and 576 are secured to one another so that they are fixed relative to one another. The adjustment of these components is illustrated in FIG. 28 at arrows W and Y. More particularly, each of members 572 and 574 is horizontally adjustable from side to side in the axial direction relative to one another and to mounting member 576, as indicated by arrows W. Elongated slots 590 and 598 allow for this movement while screws 578 are disposed respectively therein when in the loosened position. Mounting member 576 is vertically adjustable relative to members 572 and 574 as indicated at arrow Y in FIG. 28. This vertical adjustment is provided for by the vertical elongated slot 626 when bolts 578 are disposed therein in the loosened condition. The horizontal axial adjustment of members 572 and 574 allows the width W1 (FIG. 26) of channel 600 to be adjusted to accommodate shells 18 (FIG. 31) of different widths. Width W1 is defined between the inner surfaces of sidewalls 586 and 594.

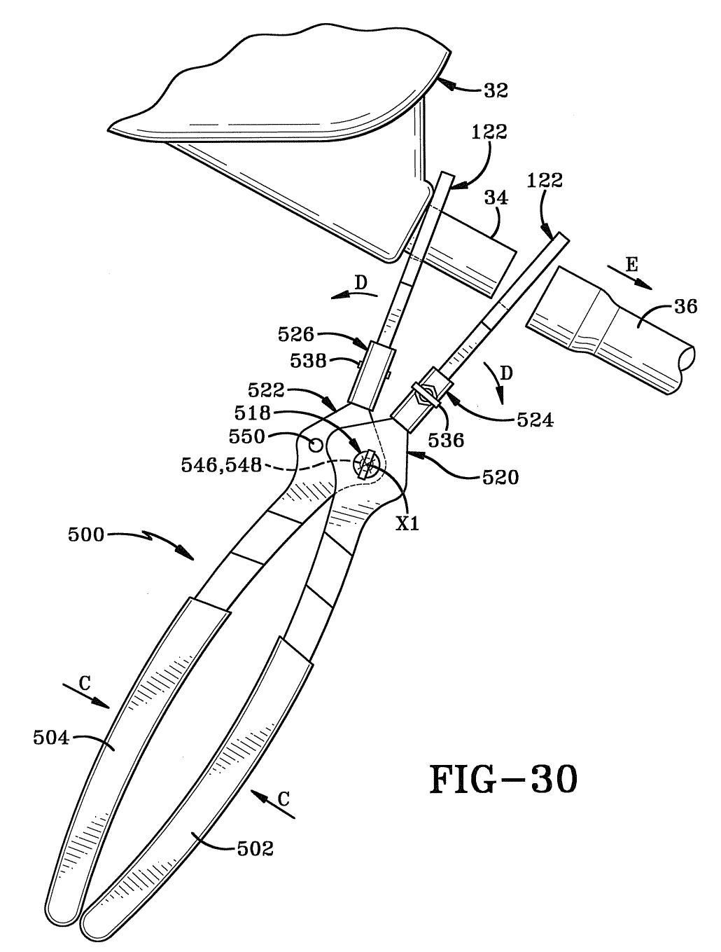

Referring now to FIG. 29, an additional attachment 630 is described. Attachment 630 serves the same purpose as attachment 182 shown in FIG. 7 although in a substantially more simplified form. Preferably, attachment 630 is formed as an integral one piece member. For purposes of description, attachment 630 has a front 632 and a back 634 defining therebetween a longitudinal direction of the attachment which corresponds to that of tool 500. Attachment 630 also has a top 636, a bottom 638, and first and second sides 640 and 642 which define therebetween an axial direction of the attachment which corresponds to that of tool 500. Attachment 630 includes a vertically oriented finger 644 which extends downwardly to a terminal lower end or tip 646 which is configured for engaging an inflation 20 (FIG. 1) for removing it from its shell 18. Finger 644 is thus a front segment of attachment 630 which thus defines its front 632. A generally horizontal bridge segment 648 at its front end is attached to the upper end of finger 644 and extends rearwardly therefrom to a rear end which is rigidly connected to an extension arm 650 which extends downwardly therefrom. Extension arm 650 serves as a generally vertical intermediate segment which at its lower end is rigidly secured to a rear segment or mounting tab 652 which has a back end 654. In the exemplary embodiment, segment 644 and 650 have about the same vertical length and thus rear segment 652 is roughly at the same height as tip 646.

When the various attachments are mounted on tool 500 with their respective mounting tabs such as tab 62 within the corresponding channel of one of the channel members 528 and 530, as shown in FIGS. 30-32, the relationship of the various components making up the attachment may be described as being closer to or further away from the corresponding axis X1 or X2, or perhaps extending radially outwardly therefrom. Thus, while the forward and rearward directions as well as upward and downward directions of a given attachment and the tool 500 shown in the exemplary embodiment may be maintained, these directions may also be varied for a tool which is altered to some degree. For instance, as was illustrated with tool 300 in FIGS. 20 and 21, arms 316 and 318 extend upwardly while arms 328 and 330 extend downwardly instead of forward relative to handles 302 and 304. Thus, with respect to attachment 630 as an example, segment 652 may be referred to as an inner segment or leg, finger 644 may be referred to as an outer segment or leg, and segments 648 and 650 may be referred to as intermediate segments or legs. Finger 644, bridge segment 648, and extension arm 650 together form a U-shaped configuration and define therewithin a shell sidewall-receiving space 656 which opens downwardly and also toward sides 640 and 642. Space 656 is thus adjacent tip 646 intermediate tip 646 and axis X2.

The operation of tool 500 with various attachments is now described with reference to FIGS. 30-32. FIG. 30 shows tool 500 removing hose 36 from port 34. More particularly, a pair of the first attachments 122 which were described in greater detail earlier in the application are mounted on attachment mounts 524 and 526 with the mounting tabs thereof within the channel members and secured by screws 536 and 538. Tool 500 is in the first orientation with pivot 518 within holes 546 and 548 so that handles 502 and 504 pivot about axis X1. Thus, when handles 502 and 504 are squeezed toward one another as indicated at arrows C in FIG. 30, the arms including attachments 122 pivot away from one another as indicated at arrows D in order to pry tube 236 off of port 34. This process is thus essentially the same as that described with regard to tool 10 and as shown in FIGS. 9 and 10.

The removal of inflation 20 from its shell 18 is shown in FIGS. 31 and 32. Tool 500 has been reconfigured from the orientation shown in FIGS. 23-25 by the unthreading of pivot 518 from hole 548, the relative movement of handles 502 and 504 to align holes 546 and 550, and the threading of pivot of 518 into hole 550 to secure handles 502 and 504 to one another so that they are pivotable about axis X2. Inflation engaging attachment 570 has been mounted on first attachment mount 524 by the rearward insertion of mounting tab 616 into the channel of channel member 528 and the tightening of screw 536, which engages the side of mounting tab 616 to clamp it between screw 536 and the opposing sidewall of channel member 528. Mounting tab 616 thus extends forward from channel member 528 so that leg 618 extends downwardly with members 572 and 574 downward of tab 616 and forward of leg 618. Inflation engaging attachment 630 is likewise mounted on second attachment mount 526 with mounting tab 652 inserted in the channel of channel member 530 and clamped therein by screw 538. Tab 652 extends forward from channel member 530 directly above mounting tab 616. Extension arm 650 extends upwardly therefrom with bridge segment 648 extending forward to the top of finger 644, which extends downwardly to tip 646, which points downwardly into channel 600 and generally toward attachment 570 of arm 520. As shown in FIG. 31A, finger 644 is centered intermediate and above sidewalls 586 and 594 when attachments 570 and 630 are mounted on tool 500.

If necessary, members 572 and 574 may be adjusted relative to one another and relative to member 576 in order to properly accommodate shell 18 and inflation 20. More particularly, nuts and bolts 578 and 582 may be loosened so that members 572 and 574 can be moved laterally relative to one another to alter width W1 (FIG. 26) so that width WI is slightly larger than the width of shell 18. The U-shaped sidewall formed by members 572 and 574 may also be moved selectively toward or away from finger 644 of arm 522 by moving vertically relative to member 576 so that shell 18 and inflation 20 are at a height suitable for the removal of inflation 20 from shell 18. For instance, the portion of shell 18 which extends between pulsation inlet port 60 and its end adjacent annular lip 254 may vary in length, thus requiring the vertical adjustment described. Thus, if this portion of channel 18 is relatively shorter, members 572 and 574 may need to be moved upwardly relative to member 576 toward finger 644 and vice versa if this portion of shell 18 is longer. This latter adjustment may be made after shell 18 is positioned within channel 600 with inlet port 60 positioned within notch 602 so that it engages surface 606. When shell 18 is positioned in this manner, finger 644 will extend upwardly beside and adjacent inflation hose 24 with tip 646 abutting shoulder 262 adjacent end 260 of cup 21. Finger 644 is typically in contact with hose 24 adjacent end 260. As shown in FIG. 31, tip 646 is positioned above the rear portion of circular hole or entrance opening 256 just forward of the rear portion of annular lip 254. Thus, the rear portion of sidewall 252 of shell 18 is positioned a short distance below space 656 with extension arm 650 spaced rearwardly of the rear portion of sidewall 252.

In order to remove inflation 20 from shell 18, handles 502 and 504 are squeezed toward one another as indicated at arrows Z in FIG. 32 so that the handles and arms 520 and 522 pivot about axis X2 with arms 520 and 522 moving toward one another as indicated by arrows M. The manual squeezing force applied to handles 502 and 504 is thus translated to a squeezing force of attachments 570 and 630 applied respectively to port 60 and shoulder 262 respectively via surface 606 and tip 646. The movement of arms 520 and 522 toward one another thus forces finger 644 downwardly relative to shell 18 so that tip 646 forces shoulder 262 to deform due to its flexible elastomeric characteristics so that shoulder 262 is forced through hole 256 and inflation 20 moves downwardly relative to shell 18 as indicated at arrow BB. During this process, a portion of finger 644 including tip 646 moves downwardly through the entrance opening or hole 256 so that tip 646 enters interior chamber 258 of shell 18 and the rear portion of shell sidewall 252 adjacent lip 254 is received within space 656. Lip 254 is thus unseated from within groove 264 during this process. Once shoulder 262 has passed through hole 256, handles 502 and 504 may be pulled apart in order to move the arms and corresponding attachments 570 and 630 away from one another so that shell 18 and inflation 20 may be removed therefrom. Once lip 254 is unseated from groove 264, inflation 20 may be manually removed the rest of the way from shell 18 by manually grasping cup 21 and pulling inflation hose 24 through opening 256 and out of interior chamber 258.

Tool 500 may also be configured in the first orientation shown in FIGS. 23-25 with shell engaging attachment 570 mounted on mount 526 with tab 616 in channel 534 thereof, and with attachment 122 mounted within channel 532 of mount 524. This configuration is similar to that of tool 10 shown in FIG. 11 and is used for the installation of inflation 20 within shell 18 as described with regard to tool 10 and with reference to FIGS. 11-14. Other than the adjustable characteristics of attachment 570, the installation of inflation 20 with tool 500 is the same as with tool 10 and is thus not shown or described again in order to eliminate unnecessary description.

Thus, the present invention provides several embodiments of hand tools used for the removal of rubber hoses from various pipes or ports while also providing for the installation and removal of an inflation from its outer shell. Tool 300 is configured for removing different sized tubes from various sized ports. Tools 10 and 500 with their various attachments and removable nature thereof allow for different configurations for achieving the various removal and installation procedures described herein.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A hand tool comprising:
first and second handles pivotally connected to one another about a first axis;
a first arm connected to the first handle and extending outwardly from adjacent the first axis;
a second arm connected to the second handle and extending outwardly from adjacent the first axis;
wherein in response to pivotal movement of the handles about the first axis toward one another, the first and second arms pivot relative to one another whereby the arms are configured for one of removing an elastomeric component from a rigid component and installing an elastomeric component on a rigid component.

2. The hand tool of claim 1 further comprising a shell-engaging component on the first arm which is configured to engage a rigid shell in which an elastomeric inflation is installed, the inflation adapted to receive a cow's teat for milking; and an inflation-engaging component on the second arm which is configured to engage the inflation whereby the hand tool is configured to remove the inflation from the shell.

3. The hand tool of claim 2 wherein the inflation-engaging component comprises a finger having a terminal end extending toward the first arm.

4. The hand tool of claim 3 further comprising a shell sidewall-receiving space formed in the inflation-engaging component adjacent the terminal end of the finger intermediate the terminal end and the first axis and configured to receive a sidewall of the shell.

5. The hand tool of claim 3 further comprising a shell-receiving channel formed in the shell-engaging component configured to receive the shell; and wherein the terminal end of the finger extends toward the channel.

6. The hand tool of claim 1 further comprising a shell-receiving channel formed in the first arm configured to receive a shell of a teat cup assembly.

7. The hand tool of claim 6 further comprising a first pulsation port engagement surface on the first arm configured to engage a pulsation port extending outwardly from the shell.

8. The hand tool of claim 7 wherein the first arm comprises a U-shaped sidewall which defines the channel.

9. The hand tool of claim 8 further comprising a first notch formed in the sidewall in communication with the channel; and wherein the first pulsation port engagement surface bounds the first notch and faces the second arm.

10. The hand tool of claim 9 further comprising a second notch formed in the sidewall in communication with the channel; and a second pulsation port engagement surface on the first arm which bounds the second notch and faces away from the second arm.

11. The hand tool of claim 8 further comprising a first notch formed in the sidewall in communication with the channel; and a first pulsation port engagement surface on the first arm which bounds the first notch and faces away from the second arm.

12. The hand tool of claim 8 wherein the first arm further comprises a mounting member which is mounted on the U-shaped sidewall so that the sidewall is adjustable relative to the mounting member toward and away from the second arm.

13. The hand tool of claim 6 wherein the first arm comprises first and second channel-forming members which are adjustably mounted on one another to define an adjustable width of the channel whereby the channel is adjustable for receiving therein shells of different widths.

14. The hand tool of claim 1 further comprising a first mounting station on the first arm configured for alternately mounting thereon a plurality of attachments; and a second mounting station on the second arm configured for alternately mounting thereon a plurality of attachments.

15. The hand tool of claim 1 wherein the first and second arms pivot away from one another in response to pivotal movement of the handles toward one another.

16. The hand tool of claim 15 further comprising a first open-ended slot formed in the first arm.

17. The hand tool of claim 16 further comprising a second open-ended slot formed in the second arm and aligned with the first open-ended slot.

18. The hand tool of claim 15 wherein the first arm comprises a sidewall defining a shell-receiving channel configured to receive a shell of a teat cup assembly; and a pulsation port-receiving notch which is formed in the sidewall, communicates with the channel and opens away from the second arm whereby the notch is configured to receive a pulsation port which extends outwardly from the shell.

19. The hand tool of claim 15 wherein the first and second handles are alternately pivotally connected to one another about a second axis which is offset from the first axis so that the first and second arms pivot toward one another in response to pivotal movement of the handles about the second axis toward one another.

20. A method comprising the step of:
positioning a hand tool comprising first and second handles pivotally connected to one another so that a first arm connected to the first handle is adjacent a rigid component and a second arm connected to the second handle is adjacent an elastomeric component; and
squeezing the first and second handles so that the handles pivot toward one another and the first and second arms pivot relative to one another to one of remove the elastomeric component from the rigid component and install the elastomeric component on the rigid component.
